(19) United States
(12) Patent Application Publication
(10) Pub. No.: US 2026/0017447 A1
(43) Pub. Date: Jan. 15, 2026

(54) Document Viewing Device

(71) Applicant: Semiconductor Energy Laboratory Co., Ltd., Kanagawa-ken (JP)

(72) Inventors: Yoshitaka DOZEN, Atsugi, Kanagawa (JP); Kunitaka YAMAMOTO, Atsugi, Kanagawa (JP)

(73) Assignee: Semiconductor Energy Laboratory Co., Ltd., Kanagawa-ken (JP)

(21) Appl. No.: 18/994,503

(22) PCT Filed: Jul. 14, 2023
(86) PCT No.: PCT/IB2023/057209

§ 371 Date: Jan. 14, 2025

(30) Foreign Application Priority Data
Jul. 28, 2022 (JP) 2022-120356

(51) Int. Cl. G06F 40/169; G06F 3/0481

(52) U.S. Cl. CPC G06F 40/169; G06F 3/0481

(57) ABSTRACT

A document viewing device that contributes to smooth execution of the work is provided. The document viewing device includes an input unit, a registration unit, a display control unit, and a display unit. The input unit has a function of receiving a document designated by a user. The registration unit has a function of registering a comment in a comment-given portion that is part of the document. The display control unit has a function of making the display unit display the comment so that the user can be made aware that whether a person who has registered the comment is the user or any of the other users different from the user.

### TECHNICAL FIELD

One embodiment of the present invention relates to a document viewing device. Another embodiment of the present invention relates to a method for viewing a document. Another embodiment of the present invention relates to a document viewing system.

Note that one embodiment of the present invention is not limited to the above technical field. Examples of the technical field of one embodiment of the present invention include a semiconductor device, a display device, a light-emitting device, a power storage device, a memory device, an electronic device, a lighting device, a method for driving any of them, and a method for manufacturing any of them.

### BACKGROUND ART

In recent years, the importance of intellectual property right has been increased. For example, a company obtains a patent right and exercises its right to work the invention exclusively, resulting in earning a large profit. Here, when work relating to intellectual property rights is carried out in a company, for example, sharing information is important for smooth execution of the work. Patent Document 1 discloses an information processing device for a single case relating to intellectual properties on which a plurality of people work; the information processing device sends information to each person in charge.

### Reference

### Patent Document

[Patent Document 1] Japanese Published Patent Application No. 2001-325389

### SUMMARY OF THE INVENTION

### Problems to be Solved by the Invention

When a plurality of people are in charge of a single case, sharing information between the plurality of people in charge of the case enables smooth review. For example, in the case where a plurality of people are in charge of application of one patent, the comments made, by one of the people in charge, on a patent application document such as a specification and drawings are shared by the plurality of people. This makes it possible to understand the invention in a short time.

An object of one embodiment of the present invention is to provide a document viewing device that enables information to be shared between a plurality of people. Another object of one embodiment of the present invention is to provide a document viewing device that contributes to smooth execution of work. Another object of one embodiment of the present invention is to provide a highly convenient document viewing device. Another object of one embodiment of the present invention is to provide a novel document viewing device. Another object of one embodiment of the present invention is to provide a method for viewing a document using the above document viewing device. Another object of one embodiment of the present invention is to provide a document viewing system including the document viewing device.

Note that the description of these objects does not preclude the existence of other objects. One embodiment of the present invention does not necessarily need to achieve all of these objects. Other objects can be derived from the description of the specification, the drawings, and the claims.

### Means for Solving the Problems

One embodiment of the present invention is a document viewing device including an input unit, a registration unit, a display control unit, and a display unit; the input unit has a function of receiving a document designated by a user; the registration unit has a function of registering a comment in a comment-given portion that is a part of the document; and the display control unit has a function of making the display unit display the comment so that the user can be made aware that whether a person who has registered the comment is the user or any of the other users.

In the above embodiment, the registration unit may have a function of registering the part of the document as a remarkable point, and the display control unit may have a function of making the display unit display the remarkable point so that the user can be made aware that whether a person who has registered the remarkable point is the user or any of the other users.

Alternatively, in the above embodiment, the display control unit may have a function of controlling whether or not to make the display unit display the comment depending on an attribute of any of the other users.

Alternatively, in the above embodiment, the display control unit may have a function of controlling whether or not to make the display unit display the comment depending on an attribute of any of the other users who has registered the comment, and the display control unit may have a function of controlling whether or not to make the display unit display the remarkable point depending on an attribute of any of the other users who has registered the remarkable point. Alternatively, in the above embodiment, the document may be hierarchized with a heading and a main text linked to the heading, and the display control unit may have a function of making the display unit display the comment when the comment-given portion is included in a hierarchical level designated by the user.

Alternatively, in the above embodiment, the document may be hierarchized with a heading and a main text linked to the heading, the display control unit may have a function of making the display unit display the comment when the comment-given portion is included in a hierarchical level designated by the user, and the display control unit may have a function of making the display unit display the remarkable point when the remarkable point is included in a hierarchical level designated by the user.

Alternatively, in the above embodiment, the display control unit may have a function of controlling whether or not to make the display unit display the comment depending on the content of the comment.

Alternatively, in the above embodiment, the display control unit may have a function of comparing the comment and a sentence included in a predetermined range of the document and controlling whether or not to make the display unit display the comment, and the predetermined range may include the comment-given portion.

Alternatively, in the above embodiment, when the comment includes a first comment and a second comment, the display control unit may have a function of comparing the first comment and the second comment and controlling whether both the first comment and the second comment are displayed on the display unit or only one of the first comment and the second comment is displayed on the display unit.

Alternatively, in the above embodiment, the display control unit may have a function of calculating a first similarity that is a similarity between the first comment and the second comment and making the display unit display only one of the first comment and the second comment when the first similarity is higher than or equal to a predetermined value.

Alternatively, in the above embodiment, the document viewing device may include a memory unit. The memory unit may store a plurality of registration documents. In any of the registration documents, the comment is given to a comment-given portion of the registration document that is a part of a sentence included in the registration document. The display control unit may have a function of calculating a second similarity that is a similarity between at least part of a sentence in the document and the sentence including the comment-given portion of the registration document and making the display unit display the comment given to the comment-given portion of the registration document when the second similarity is higher than or equal to a predetermined value.

Another embodiment of the present invention is a document viewing device including an input unit, a registration unit, a memory unit, a display control unit, and a display unit; the input unit has a function of receiving a document designated by a user; the registration unit has a function of registering a first comment in a first comment-given portion that is a part of the document; the memory unit stores a plurality of registration documents; a second comment is registered in a second comment-given portion that is a part of the registration document; the display control unit has a function of making the display unit display the first comment; and the display control unit has a function of comparing the first comment and the second comment and controlling whether or not to make the display unit display the second comment-given portion.

Alternatively, in the above embodiment, the display control unit may have a function of calculating a first similarity that is a similarity between the first comment and the second comment and making the display unit display the second comment-given portion when the first similarity is higher than or equal to a predetermined value.

Alternatively, in the above embodiment, the display control unit may have a function of making the display unit display the first comment so that the user can be made aware that whether a person who has registered the first comment is the user or any of the other users.

Alternatively, in the above embodiment, the display control unit may have a function of controlling whether or not to make the display unit display the first comment depending on a relation between an attribute of the user and an attribute of any of the other users.

Alternatively, in the above embodiment, each of the document and the registration document may be hierarchized with a heading and a main text linked to the heading, and the display control unit may have a function of inhibiting the display unit from displaying the first comment and the second comment when the first comment-given portion is not included in a hierarchical level designated by the user.

Alternatively, in the above embodiment, the display control unit may have a function of controlling whether or not to make the display unit display the first comment and the second comment depending on the content of the first comment.

Alternatively, in the above embodiment, the display control unit may have a function of comparing the first comment and a sentence included in a predetermined range of the document and controlling whether or not to make the display unit display the first comment and the second comment, and the predetermined range may include the first comment-given portion.

Alternatively, in the above embodiment, when a plurality of first comments are registered in the document, the display control unit may have a function of comparing the plurality of first comments and controlling whether to display all the first comments or only some of the first comments on the display unit.

Alternatively, in the above embodiment, the display control unit may have a function of calculating second similarities that are each a similarity between the plurality of first comments and making the display unit display only some of the first comments whose second similarity is higher than or equal to a predetermined value.

Alternatively, in the above embodiment, the registration unit may have a function of registering a part of the document as a remarkable point, and the display control unit may have a function of making the display unit display the remarkable point so that the user can be made aware that whether a person who has registered the remarkable point is the user or any of the other users.

### Effect of the Invention

According to one embodiment of the present invention, a document viewing device enabling information to be shared between a plurality of people can be provided. According to another embodiment of the present invention, a document viewing device that contributes to smooth execution of the work can be provided. According to another embodiment of the present invention, a highly convenient document viewing device can be provided. According to another embodiment of the present invention, a novel document viewing device can be provided. According to another embodiment of the present invention, a method for viewing a document using the document viewing device can be provided. According to another embodiment of the present invention, a document viewing system including the document viewing device can be provided.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

FIG. 1 is a block diagram illustrating a structure example of a document viewing device.

FIG. 2A and FIG. 2B are schematic diagrams each illustrating an example of document data.

FIG. 3A is a schematic diagram illustrating an example of comment data. FIG. 3B is a schematic diagram illustrating an example of remarkable data. FIG. 3C is a schematic diagram illustrating an example of user's data.

FIG. 4A and FIG. 4B are schematic diagrams each illustrating an example of a display screen.

FIG. 5A and FIG. 5B are schematic diagrams each illustrating an example of a display screen.

FIG. 6A is a schematic diagram illustrating an example of comment data. FIG. 6B is a schematic diagram illustrating an example of remarkable data. FIG. 6C is a schematic diagram illustrating an example of a display screen.

FIG. 7A is a schematic diagram illustrating an example of comment data. FIG. 7B is a schematic diagram illustrating an example of a display screen.

FIG. 8A is a schematic diagram illustrating an example of comment data. FIG. 8B1 and FIG. 8B2 are schematic diagrams each illustrating an example of a display screen.

FIG. 9 is a schematic diagram illustrating an example of data stored in a memory unit.

FIG. 10 is a flowchart showing an example of a document viewing method.

FIG. 11A is a schematic diagram illustrating an example of a document viewing method. FIG. 11B is a schematic diagram illustrating an example of a display screen.

FIG. 12 is a flowchart showing an example of a document viewing method.

FIG. 13 a schematic diagram illustrating an example of a display screen.

FIG. 14 is a diagram illustrating an example of a document viewing system.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments.

### Embodiment 1

In this embodiment, a document viewing device and a method for viewing the document of one embodiment of the present invention will be described with reference to drawings.

One embodiment of the present invention relates to, for example, a document viewing device enabling a document relating to intellectual property to be viewed. The use of the document viewing device can be shared between a plurality of people in an organization. With the document viewing device of one embodiment of the present invention, a comment which a user has left on part of the document can be viewed by another user. Accordingly, information represented by the comment can be shared between the plurality of people. Furthermore, with the document viewing device of one embodiment of the present invention, for example, a sentence and a drawing which a user check out of sentences and drawings included in the document can be shown as remarkable points to the other user. Accordingly, the highly important sentence and drawing can be shared between the plurality of people, for example. Thus, with use of the document viewing device of one embodiment of the present invention, the work can be smoothly executed.

### Structure Example of Document Viewing Device

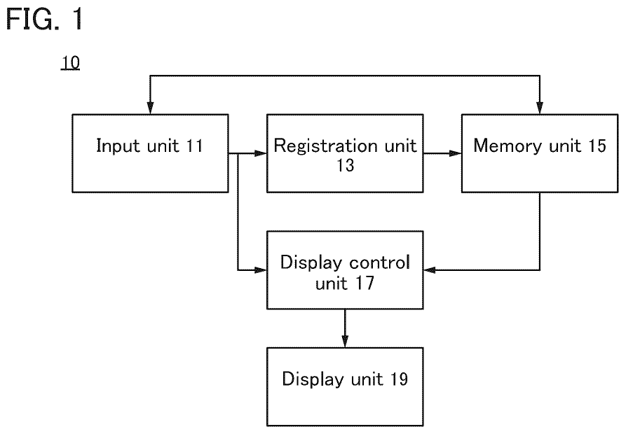

FIG. 1 is a block diagram illustrating a structure example of a document viewing device 10. The document viewing device 10 includes an input unit 11, a registration unit 13, a memory unit 15, a display control unit 17, and a display unit 19.

In FIG. 1, exchange of data or the like between the components of the document viewing device 10 is denoted by arrows. Note that the exchange of data or the like shown in FIG. 1 is an example, and data or the like can be sometimes exchanged between components that are not connected by an arrow, for example. Furthermore, data or the like is not exchanged between components that are connected by an arrow in some cases.

The use of the document viewing device 10 can be shared between a plurality of people in an organization such as a company. Of the components in the document viewing device 10, the input unit 11 and the display unit 19 can be provided in an information processing device such as a personal computer (PC), and the registration unit 13, the memory unit 15, and the display control unit 17 can be provided in a server, for example. Note that part of the input unit 11 and part of the display unit 19 may be provided in the server. Part of the registration unit 13, part of the memory unit 15, and part of the display control unit 17 may be provided in a client PC. The client PC and the server can exchange data or the like via a network, for example.

Although FIG. 1 is the block diagram, for example, showing that components are classified by their functions and illustrated as independent blocks, it is difficult to completely divide actual components according to their functions and one component can relate to a plurality of functions. Moreover, one function can relate to a plurality of components; for example, a plurality of processes conducted in the registration unit 13 or the display control unit 17 may be executed by servers different from each other. Furthermore, some of the plurality of processes conducted in the registration unit 13 or the display control unit 17 may be executed by the client PC and the other processes may be executed by the server.

### Input Unit 11

To the input unit 11, data is supplied from the outside of the document viewing device 10. The data supplied to the input unit 11 is supplied to the registration unit 13, the memory unit 15, or the display control unit 17. Data stored in the memory unit 15 can be supplied to the input unit 11.

For example, document data can be input to the input unit 11. Specifically, a document designated by a user of the document viewing device 10 can be input as document data to the input unit 11.

Examples of a document that can be input to the input unit 11 include a document relating to intellectual property rights. Examples of the document relating to intellectual property rights include a patent application document, a utility model registration application document, an international application document, a trademark registration application document, a trademark registration application document, a published patent application, a patent publication, a utility model publication, an international publication, a design publication, an international designs bulletin, a published trademark application, a published international trademark application, and a trademark publication. Here, the patent application document can include a specification, drawings, claims, an abstract, and an application. The utility model registration application document can include a specification, drawings, claims for utility model registration, an abstract, and an application. The international application document can include a specification, drawings, claims, an abstract, and an application. The design registration application document can include an application and drawings. Furthermore, the design registration application document can include an application. There is no limitation on statuses of the above applications, i.e., whether or not it is published, whether or not it is pending in the Patent Office, and whether or not it is registered. Any of a document before application, an application document before examination, an application document under examination, and a registered application document can be input to the input unit 11.

Note that the document that can be input to the input unit 11 is not limited to a document relating to intellectual property rights, and a technical document such as a paper or a legal document may be input, for example. Examples of the legal document include a contract, terms and conditions, and precedents. Alternatively, at least one of a book, a magazine, a newspaper, a product manual, a novel, and a white paper may be input to the input unit 11.

Note that not all the above document, the publication, and the like are not necessarily input to the input unit 11, and only some of the components may be input. For example, out of the specification, the drawings, the claims, the abstract, and the application included in the patent application document, only the specification and the drawings may be input to the input unit 11.

Here, for example, in the case where a document stored in the memory unit 15 is input to the input unit 11, a user designates information specifying the document, whereby the document can be input. Examples of information specifying a document include identification numbers (IDentification: ID) assigned to respective documents. For example, the document can be specified by one or more of a title given to the document, the date such as an issue date of a document, a creator of the document, a publisher, sentences included in the document, and the like. For example, assuming that a published patent application is a document to be input to the input unit 11, the document can be specified by designating one or more of an application management number for identifying an application (including an internal unique number), an application family management number for identifying an application family, an application number, a publication number, a registration number, an inventor, an applicant, a drawing, an abstract, an application date, a priority date, a publication date, a status, a patent classification, a category, and a keyword, for example.

In this specification and the like, ID may include not only numbers but also characters. In this specification and the like, characters include symbols.

When a plurality of pieces of information are prepared for specifying a document, the document viewing device 10 can be a highly convenient document viewing device. A document to be input to the input unit 11 is preferably allowed to be designated by a user designating part of the above information. For example, it is preferable to allow a document to be input to the input unit 11 to be specified only by designating not the whole but part of a title given to the document, in which case the convenience of the document viewing device 10 can be increased. When a document to be input to the input unit 11 can be specified on the basis of information registered in a device other than the document viewing device 10, the convenience of the document viewing device 10 can be further increased.

The input unit 11 has a function of authenticating a user of the document viewing device 10. For example, when a user of the document viewing device 10 inputs ID (also referred to as a user ID) and a password to the input unit 11, the document viewing device 10 enables user authentication. Note that the document viewing device 10 may have a function of conducting authentication on the basis of a figure which a user inputs to the input unit 11 or a function of conducting biometric authentication using fingerprints, voice prints, or the like. In addition, an authentication unit may be provided in the document viewing device 10 so that the authentication unit conducts user authentication.

### Registration Unit 13

The registration unit 13 has a function of registering a comment in a document input to the input unit 11, for example. The registered comment is given to at least part of the document. For example, when the text in the document is separated into paragraphs, a comment can be given to any of the paragraph. For another example, a comment can be given to one or a plurality of sentences included in the paragraph. For another example, a comment can be given to one character or a plurality of characters that are consecutive included in a sentence. In the case where drawings are included in the document, a comment can be given to one or a plurality of the drawings.

The registration unit 13 has a function of registering part of a document input to the input unit 11 as a remarkable point. The remarkable point can be registered per paragraph of the text or per drawing, for example. Alternatively, a remarkable point may be registered per sentence, for example. One character or a plurality of characters that are consecutive included in a sentence may be registered as a remarkable point, for example.

Any of users of the document viewing device 10 can register a comment and a remarkable point. For example, a user who has input a document to the input unit 11 can conduct the registration. For example, with respect to a document which a user has input to the input unit 11, the user designates a paragraph, a drawing, or the like and inputs a comment, thereby being capable of registering the comment. Furthermore, with respect to a document which a user has input to the input unit 11, the user designates a paragraph, a drawing, or the like that is to be registered as a remarkable point, thereby being capable of registering the remarkable point. In the case where the user of the document viewing device 10 conducts the registration of the comment and the remarkable point, the input unit 11 has a function of receiving the designation of the comment and the remarkable point.

### Memory Unit 15

The memory unit 15 has a function of storing data that is necessary for the document viewing device 10 to execute processing. The memory unit 15 can store a document that can be input to the above-described input unit 11 as document data, for example. The memory unit 15 can store, as document data, a document including at least one of a comment and a remarkable point registered by the registration unit 13, for example. Here, in the case where a document is stored in the memory unit 15, it can be said that a document database is constructed in the memory unit 15.

In this specification and the like, a document stored in the memory unit 15 is referred to as a registration document.

A recording media drive such as a hard disk drive (HDD) or a solid state drive (SSD) may also be used for the memory unit 15, for example. In addition, the memory unit 15 may include a nonvolatile memory such as an ReRAM (Resistive Random Access Memory, also referred to as a resistance-change memory), a PRAM (Phase-change Random Access Memory), an FeRAM (Ferroelectric Random Access Memory), an MRAM (Magnetoresistive Random Access Memory, also referred to a magneto-resistive memory), a flash memory, a NOSRAM (registered trademark), or a DOSRAM (registered trademark). Furthermore, a volatile memory such as a DRAM (Dynamic Random Access Memory) or an SRAM (Static Random Access Memory) may be provided in the memory unit 15.

For example, a NOSRAM (registered trademark) is an abbreviation for “Nonvolatile Oxide Semiconductor Random Access Memory (RAM)”. A NOSRAM is a memory in which a memory cell is a 2-transistor (2T) or 3-transistor (3T) type gain cell and the transistor includes a metal oxide in a channel formation region (also referred to as an OS transistor). A current flowing between a source and a drain in an off state, that is, a leakage current, is extremely low in an OS transistor. The NOSRAM can be used as a nonvolatile memory by retaining electric charge corresponding to data in the memory cells, using characteristics of extremely low leakage current. In particular, the NOSRAM is capable of reading retained data without destruction (non-destructive reading), and thus is suitable for arithmetic processing in which only data reading operation is repeated many times. Since the NOSRAM that is provided to have a stacked-layer structure can have large data capacity, when the NOSRAM is used as a large cache memory, a main memory, or a storage memory, the performance of the semiconductor device can be increased.

A DOSRAM (registered trademark) is an abbreviation for “Dynamic Oxide Semiconductor RAM,” which indicates a RAM including a 1T (transistor) 1C (capacitor)-type memory cell. The DOSRAM is a DRAM formed using an OS transistor, and the DOSRAM is a memory that temporarily stores information sent from the outside. The DOSRAM is a memory utilizing a low off-state current of an OS transistor.

In this specification and the like, a metal oxide is an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in an active layer of a transistor, the metal oxide is referred to as an oxide semiconductor in some cases. That is, in the case where an OS transistor is stated, the OS transistor can also be referred to as a transistor including a metal oxide or an oxide semiconductor.

Examples of a metal oxide used in the OS transistors include indium oxide, gallium oxide, and zinc oxide. The metal oxide preferably contains two or three selected from indium, an element M, and zinc. Note that the element M is one or more kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, and magnesium. In particular, the element M is preferably one or more kinds selected from aluminum, gallium, yttrium, and tin.

It is particularly preferable to use an oxide containing indium (In), gallium (Ga), and zinc (Zn) (also referred to as IGZO) for the metal oxide. Alternatively, it is preferable to use an oxide containing indium, tin, and zinc (also referred to as ITZO (registered trademark)). Alternatively, it is preferable to use an oxide containing indium, gallium, tin, and zinc. Alternatively, it is preferable to use an oxide containing indium (In), aluminum (Al), and zinc (Zn) (also referred to as IAZO). Alternatively, it is preferable to use an oxide containing indium (In), aluminum (Al), gallium (Ga), and zinc (Zn) (also referred to as IAGZO). Alternatively, it is preferable to use an oxide containing indium (In), gallium (Ga), zinc (Zn), and tin (Sn) (also referred to as IGZTO).

### Display Control Unit 17

The display control unit 17 has a function of controlling information to be displayed on the display unit 19. The display control unit 17, for example, generates a display signal and supplies it to the display unit 19, thereby being capable of displaying predetermined information on the display unit 19.

For example, the display control unit 17 has a function of extracting necessary information from a document input to the input unit 11 and a document (registration document) stored in the memory unit 15 and displaying the necessary information on the display unit 19. For example, the display control unit 17 has a function of displaying a document input to the input unit 11 and a comment registered in the document. In addition, the display control unit 17 has a function of emphasizing a remarkable point registered in the document. Here, the display control unit 17 makes the display unit 19 display the registered comment and remarkable point so that a user can be made aware that whether a registrant (a person who has registered the comment and remarkable point) is a user (a person who has designated data to be input to the input unit 11) or any of the other users different from the user. For example, the display control unit 17 enables the display unit 19 to display the full names of a person who has registered the comment and a person who has registered the remarkable point. Note that the display control unit 17 compares a user ID which the user has input to the input unit 11 for authentication and a user ID of the person who has registered the comment and remarkable point, whereby the determination whether the person who has registered the comment and remarkable point is the user or any of the other users can be made. When the user ID which the user has input to the input unit 11 for authentication and the user ID of the person who has registered the comment and remarkable point are equal to each other, the display control unit 17 enables the identification such that the person who has registered the comment and remarkable point is the user; when those user IDs are different, the display control unit 17 enables the identification such that the person who has registered the comment and remarkable point is any of the other users.

For example, the display control unit 17 may have a function of executing predetermined processing on the basis of the data input to the input unit 11 and the data stored in the memory unit 15 and displaying the processing result on the display unit 19. For example, the display control unit 17 may have a function of analyzing the content of the comment and controlling whether or not to make the display unit 19 display the comment depending on the analysis result. In addition, when a plurality of comments are registered in one document, the display control unit 17 may have a function of calculating a similarity between the comments and controlling whether or not to make the display unit 19 display the comment depending on the similarity.

Furthermore, the display control unit 17 may have a function of comparing a comment and a sentence included in a predetermined range of the document where the comment is registered and controlling whether or not to make the display unit 19 display the comment. For example, the display control unit 17 may have a function of comparing a comment and a sentence to which the comment is given and controlling whether or not to make the display unit 19 display the comment depending on the comparison result.

Furthermore, the display control unit 17 may have a function of making the display unit 19 display a comment registered in the registration document. For example, the function may be such as to calculate a similarity between at least part of a sentence included in a document input to the input unit 11 and a portion of the registration document where a comment is given (also referred to as a comment-given portion of the registration document) and to control whether or not to make the display unit 19 display the comment registered in the registration document depending on the similarity. Furthermore, the display control unit 17 may have a function of comparing a comment registered in a document input to the input unit 11 and a comment registered in the registration document. The display control unit 17 can control whether or not to make the display unit 19 display the comment-given portion of the registration document depending on the comparison result.

The display control unit 17 can include, for example, a central processing unit (CPU). The display control unit 17 may include a microprocessor such as a DSP (Digital Signal Processor) or a GPU (Graphics Processing Unit). The microprocessor may be constructed with a PLD (Programmable Logic Device) such as an FPGA (Field Programmable Gate Array) or an FPAA (Field Programmable Analog Array). The display control unit 17 can interpret and execute instructions from programs with use of a processor to process various kinds of data and control programs. The programs that can be executed by the processor may be stored in a memory region included in the processor, for example. The registration unit 13 can have a hardware configuration similar to the hardware configuration that the display control unit 17 can have. The register unit 13 and the display control unit 17 are collectively referred to as a processing unit.

The display control unit 17 may include a main memory. The main memory includes at least one of a volatile memory such as a RAM and a nonvolatile memory such as a ROM (Read Only Memory).

For example, a DRAM, an SRAM, and the like are used as the RAM, a virtual memory space is assigned in the RAM and utilized as a working space of the display control unit 17.

In the ROM, a BIOS (Basic Input/Output System), firmware, and the like for which rewriting is not needed can be stored. Examples of the ROM include a mask ROM, an OTPROM (One Time Programmable Read Only Memory), and an EPROM (Erasable Programmable Read Only Memory). Examples of the EPROM include a UV-EPROM (Ultra-Violet Erasable Programmable Read Only Memory) which can erase stored data by ultraviolet irradiation, an EEPROM (Electrically Erasable Programmable Read Only Memory), and a flash memory.

### Display Unit 19

The display unit 19 has a function of displaying information on the basis of the display signal generated by the display control unit 17, for example. With the display unit 19, the document viewing device 10 can show necessary information to a user. The display unit 19 includes, for example, a light-emitting element containing an organic electroluminescence (Electro Luminescence) material, a light-emitting element containing a light-emitting diode such as a micro LED, a liquid crystal element, and the like.

As described above, the document viewing device 10 enables the comment and the remarkable point to be registered in the document and to be displayed on the display unit 19. Thus, the user of the document viewing device 10 can easily check an important part of the document, for example. In addition, the user of the document viewing device 10 can advance the reading comprehension, leaving a memo as a comment, so that the understanding of the document can be deepened. Thus, the document viewing device 10 can be a highly convenient document viewing device.

As described above, the use of the document viewing device 10 can be shared between a plurality of people in an organization such as a company. With use of the document viewing device 10, the comment and remarkable point which the user has registered in the document can be viewed by another user. Thus, information represented by the comment and highly important sentence and drawing, and the like can be shared by the plurality of people. Consequently, with use of the document viewing device 10, the work can be executed smoothly. For example, in the case where a plurality of people are in charge of one patent application, the comment made, by one of the people, on the patent application document such as a specification and drawings is shared between the plurality of people. This makes it possible to understand the invention in a short time. Moreover, highly important sentence and drawing, and the like are shared between a plurality of people, whereby an item with high importance can be considered intensively.

### Example of Data

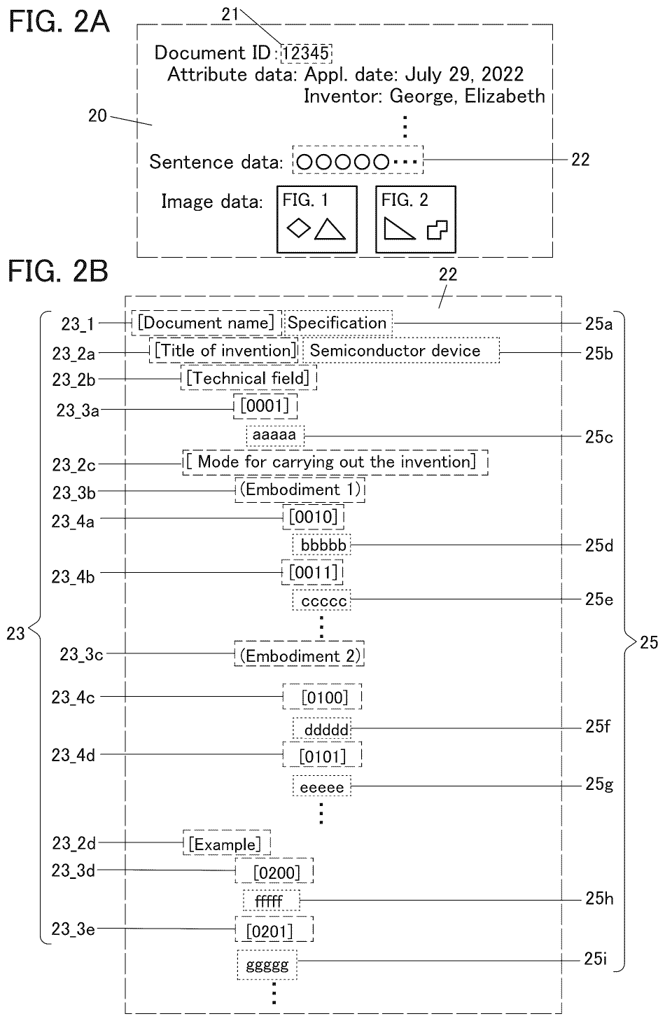

FIG. 2A is a schematic diagram illustrating an example of document data 20 representing a document input to the input unit 11. The document data 20 includes a document ID 21, attribute data, sentence data 22, and image data. An example in which the document data 20 is a patent application document is described below. Note that sentence data can be referred to as text data, and the sentence can be referred to as text in some cases.

The document ID 21 is a number for identifying the document data 20 and can be, for example, an application management number. When a user of the document viewing device 10 designates the document ID 21, for example, a document to be input to the input unit 11 is specified.

The attribute data is data representing an attribute that is information on the document data 20. FIG. 2A illustrates the application date and the inventor as examples of the attributes; the application date is “Jul. 29, 2022” and the inventors are “George” and “Elizabeth”. Here, the attribute data can include, in addition to the application date and the inventor, an application number, a publication number, a registration number, an applicant, a priority date, a publication date, a status, and patent classification, for example. Note that the attributes included in the attribute data are not limited to the items described in the document represented by the document data 20. For example, a category, a keyword, and the like that are originally assigned to the document data 20 by the user of the document viewing device 10 can also be included in the attribute data.

The sentence data 22 is data representing information represented by a sentence. Examples of the information represented by the sentence data 22 include an application, a specification, claims, and an abstract.

Image data is data representing information represented by an image. Examples of the information represented by the image data include a drawing.

FIG. 2B is a schematic diagram illustrating an example of the sentence data 22. FIG. 2B illustrates a specification as an example of the sentence data 22.

The sentence data 22 includes a heading 23 and a main text 25. In a document represented by the document data 20, a document represented by the sentence data 22 is hierarchized with the heading 23 and the main text 25 linked to the heading 23. In FIG. 2B, the hierarchical structure of the sentence data 22 is constructed with indents (also referred to as indentation), and the number of indents is larger as the hierarchical level becomes lower. In this specification and the like, the hierarchical level is denoted by reference numerals such as “_1” and “_2”; the larger the number is, the lower the hierarchical level is. In this specification and the like, when a plurality of components are denoted by the same reference numeral and in particular need to be distinguished from each other, an alphabet is sometimes added to the reference numeral. For example, in FIG. 2B, four headings 23_2 are distinguished from each other by being denoted by a heading 23_2a, a heading 23_2b, a heading 23_2c, and a heading 23_2d.

In this specification and the like, a lower-level second heading 23 linked to a first heading 23 is referred to as a lower-level heading 23 of the first heading 23. In addition, the main text 25 linked to the lower-level second heading 23 linked to the first heading 23 can be regarded to be linked to the first heading 23.

In the example illustrated in FIG. 2B, the heading 23 at the hierarchical level 1, that is, the highest-level heading 23, is referred to as a heading 23_1, and the heading 23_1 represents [Document name]. In addition, the main text 25 linked to the heading 23_1 indicates a main text 25a, and the main text 25a indicates “Specification”.

All the headings 23 at the hierarchical level 2 and the subsequent level thereof are linked to the heading 23_1. In addition, the main text 25 linked to the heading 23 linked to the heading 23 1 is also linked to the heading 23_1. Accordingly, to the heading 23_1, all the headings 23 other than the heading 23 1 and all the main texts 25 are linked.

In the example illustrated in FIG. 2B, the headings 23 at the hierarchical level 2 is a heading 23_2a, a heading 23_2b, a heading 23_2c, and a heading 23_2d; the heading 23_2a indicates [Title of invention]; the heading 23_2b indicates [Technical field]; the heading 23_2c indicates [Mode for carrying out the invention]; and the heading 23_2d indicates [Example]. The main text 25 linked to the heading 23_2a is a main text 25b, and the main text 25b indicates “Semiconductor device”.

To the heading 23_2b, a heading 23_3a at the hierarchical level 3 is linked, and to the heading 23_3a, a main text 25c is linked. In the example illustrated in FIG. 2B, the heading 23_3a indicates [0001], and the main text 25c indicates “aaaaa”. The heading 23_3a is a lower-level heading 23 of the heading 23_2b, and the main text 25c is linked to the heading 23_3a. Thus, the main text 25c is linked to the heading 23_2b.

To the heading 23_2c, a heading 23_3b and a heading 23_3c at the hierarchical level 3 are linked. In the example illustrated in FIG. 2B, the heading 23_3b indicates (Embodiment 1), and the heading 23_3 indicates (Embodiment 2).

To the heading 23_3b, a heading 23_4a and a heading 23_4b at the hierarchical level 4 are linked. To the heading 23_4a, a main text 25d is linked, and to the heading 23_4b, main text 25e is linked. In the example illustrated in FIG. 2B, the heading 23_4a indicates [0010], the heading 23_4b indicates [0011], the main text 25d indicates “bbbbb”, and the main text 25e indicates “ccccc”. The main text 25d and the main text 25e are linked to the heading 23_4a and the heading 23_4b, respectively. The heading 23_4a and the heading 23_4b are each a lower-level heading 23 of the heading 23_3b. Thus, the main text 25d and the main text 25e are linked to the heading 23_3b.

To the heading 23_3, a heading 23_4c and a heading 23_4d at the hierarchical level 4 are linked. To the heading 23_4c, a main text 25f is linked, and to the heading 23_4d, a main text 25g is linked. In the example illustrated in FIG. 2B, the heading 23_4c indicates [0100], the heading 23_4d indicates [0101], the main text 25f indicates “ddddd”, and the main text 25g indicates “eeeee”. The main text 25f and the main text 25g are linked to the heading 23_4c and the heading 23_4d respectively. The heading 23_4c and the heading 23_4d are each a lower-level heading 23 of the heading 23_3. Thus, the main text 25f and the main text 25g are linked to the heading 23_3.

Furthermore, the heading 23_3b and the heading 23_3 are each a lower-level heading 23 of the heading 23_2c. Thus, the main text 25d, the main text 25e, the main text 25f, and the main text 25g are linked to the heading 23_2c.

To the heading 23_2d, a heading 23_3d and a heading 23_3e at the hierarchical level 3 are linked. To the heading 23_3d, a main text 25h is linked, and to the heading 23_3e, a main text 25i is linked. In the example illustrated in FIG. 2B, the heading 23_3d indicates [0200], the heading 23_3e indicates [0201], the main text 25h indicates “fffff”, and the main text 25i indicates “ggggg”. The main text 25h and the main text 25i are linked to the heading 23_3d and the heading 23_3e respectively. The heading 23_3d and the heading 23_3e are each a lower-level heading 23 of the heading 23_2d. Thus, the main text 25h and the main text 25i are linked to the heading 23_2d.

As described above, the document represented by the sentence data 22 can have a hierarchical structure. Note that the heading 23_3a, the heading 23_4a, the heading 23_4b, the heading 23_4c, the heading 23_4d, the heading 23_3d, and the heading 23_3e are each also referred to as a paragraph number.

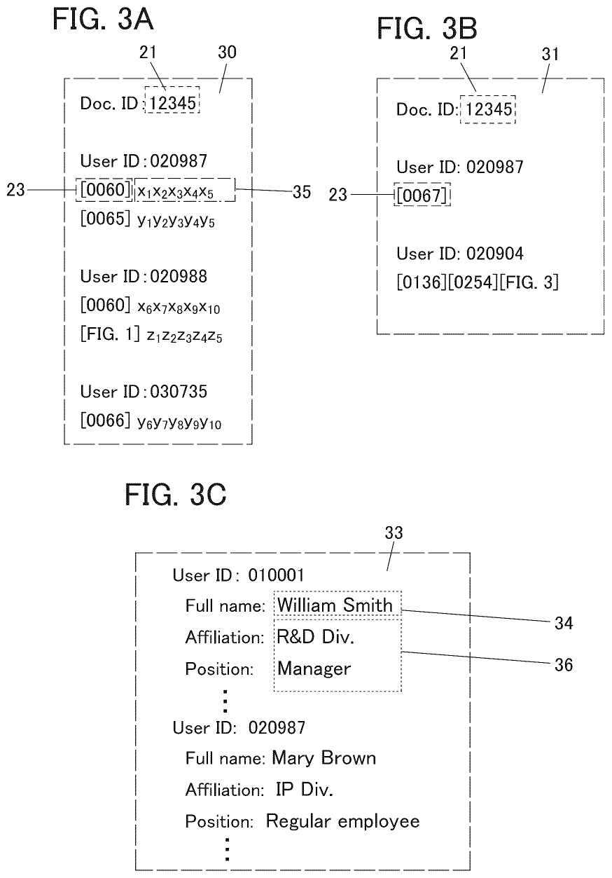

The document viewing device 10 enables a comment to be registered in the document data 20. Specifically, the document viewing device 10 enables the registration of the comment in the document data 20 with use of the registration unit 13. FIG. 3A is a schematic diagram illustrating an example of comment data 30 representing a comment registered in the document data 20.

The comment data 30 includes the document ID 21, a user ID, the heading 23, and a comment 35.

The document ID 21 indicates the document data 20 in which the comment 35 that is the comment represented by the comment data 30 is registered. FIG. 3A illustrates an example of a comment registered in the document data 20 whose document ID 21 is “12345”.

The user ID is a number for identifying a user who has registered the comment 35. The heading 23 indicates a portion to which the comment 35 is given (comment-given portion), which can make the comment 35 to be given to the main text 25 linked to the heading 23, for example. Here, a figure number linked to an image represented by image data can also be the heading 23.

The example illustrated in FIG. 3A is such that a user whose user ID is “020987” gives “x₁x₂x₃x₄x₅” as the comment 35 to the paragraph [0060] and gives “y₁y₂y₃y₄y₅” as the comment 35 to the paragraph [0065]. The example in FIG. 3A also illustrates that a user whose user ID is “020988” gives “x₆x₇x₈x₉x₁₀” as the comment 35 to the paragraph [0060] and gives “z₁z₂z₃z₄z₅” as the comment 35 to “FIG. 1”. Furthermore, the example in FIG. 3A illustrates that a user whose user ID is “030735” gives “y₆y₇y₈y₉y₁₀” as the comment 35 to the paragraph [0066]. Although one comment 35 is given to one heading 23 in FIG. 3A, one comment 35 may be given to a plurality of headings 23. For example, “x₁x₂x₃x₄x₅” may be given as the comment 35 to the paragraph in addition to the paragraph [0060].

Note that the comment 35 does not need to be given to any of units separated by the heading 23. For example, the comment can be given to one or a plurality of sentences. Furthermore, the comment can be given to one character or a plurality of characters that are consecutive included in a sentence, for example. When the comment 35 is not given to any of units separated by the heading 23, the comment data 30 can include a sentence or character to which the comment 35 is given, as information representing a portion to which the comment 35 is given, instead of the heading 23.

FIG. 3B is a schematic diagram illustrating an example of remarkable data 31 denoting a remarkable point registered in the document data 20.

The remarkable data 31 is different from the comment data 30 in not including the comment 35. The example illustrated in FIG. 3B is a remarkable point registered in the document data 20 whose document ID 21 is “12345”.

The example in FIG. 3B illustrates that a user whose user ID is “020987” registers the paragraph [0067] as a remarkable point. The example in FIG. 3B also illustrates that a user whose user ID is “020904” registers the paragraph [0136], the paragraph [0254], and “FIG. 3” as remarkable points.

Note that the remarkable point does not need to be registered in any of units separated by the heading 23. For example, the remarkable point may be registered in any of sentences. Furthermore, the remarkable point may be registered with respect to one character or a plurality of characters that are consecutive in the sentence. When the remarkable point is not registered in any of units separated by the heading 23, the remarkable data 31 can include a sentence or character that has been registered as the remarkable point, as information indicating the remarkable point, instead of the heading 23.

As illustrated in FIG. 3A and FIG. 3B, the comment and remarkable point registered in the document data 20 can be managed per user of the document viewing device 10. Accordingly, even when a plurality of people use the document viewing device 10, the comment and remarkable point registered by one user can be prevented from being edited by another user, for example. Thus, the integrity of data can be secured.

FIG. 3C is a schematic diagram illustrating an example of user data 33 representing information on a user of the document viewing device 10. The user data 33 includes a user ID, a full name 34, and an attribute 36. The full name 34 and the attribute 36 are registered for each user ID.

The full name 34 shows a full name of a user represented by the user ID. The attribute 36 shows information on the user other than the full name. Note that the full name 34 may be included in the attribute 36.

In FIG. 3C, an affiliation and a position of the user are shown as the attribute 36. An example in FIG. 3C illustrates that the full name 34 of a user whose user ID is “0100001” is “William Smith”, the attribute 36 that is an affiliation thereof is “Research and Development division”, and the position thereof is “Manager”. The example in FIG. 3C also illustrates that the full name 34 of a user whose user ID is “020987” is “Mary Brown”, the attribute 36 that is an affiliation thereof is “Intellectual Property division”, and the position thereof is “Regular employee”. Here the attribute 36 may include information on at least one of personal evaluation, a project name the user is joining, and personal affairs, for example.

Although the full name 34 in FIG. 3C includes both the family name and the personal name, only one of the family name and the personal name may be included. Even though the full name in structures described below is regarded as including both the family name and the personal name, the full name may include only one of the family name and the personal name. The user ID may include information relating to the attribute 36. In the example illustrated in FIG. 3C, the first two digits of the user ID represent an affiliation; specifically, “01” represents “Research and Development division”, and “02” represents “Intellectual Property division”.

All of the comment data 30 illustrated in FIG. 3A, the remarkable data 31 illustrated in FIG. 3B, and the user data 33 illustrated in FIG. 3C can be stored in the memory unit 15.

### Display Screen Example_1

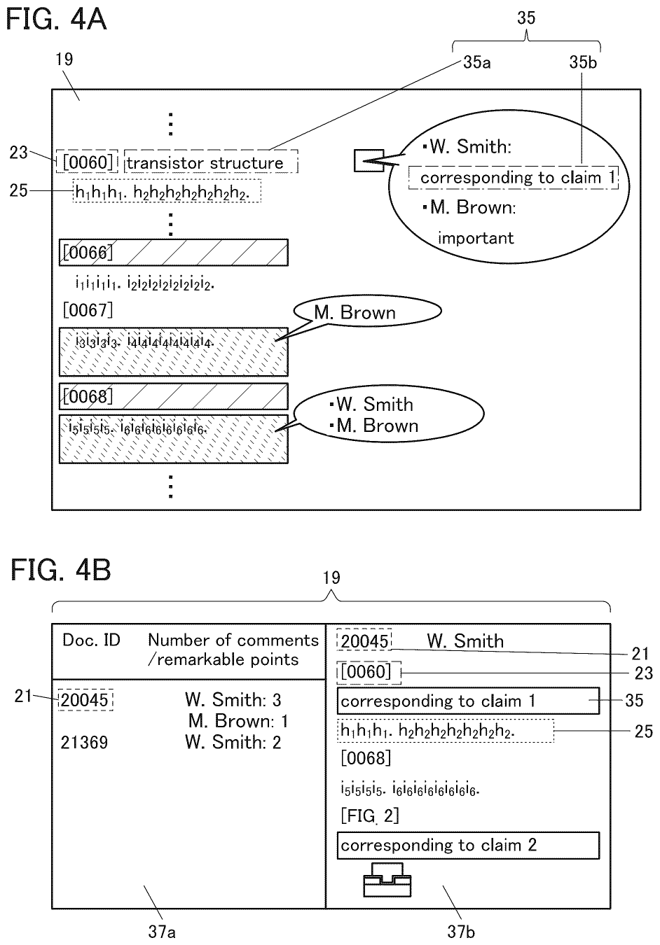

FIG. 4A is a schematic diagram illustrating an example of a display screen of the display unit 19. The example in FIG. 4A illustrates that the heading 23 and the main text 25 linked to the heading 23 are displayed on the display unit 19. As a specific example of the heading 23, the paragraph number is shown in FIG. 4A.

As illustrated in FIG. 4A, the display unit 19 enables the comment 35 registered in a document input to the input unit 11 to be displayed so that a user can find a comment-given portion. Here, the display unit 19 displays the comment 35 so that a user can be made aware that whether a person who has registered the comment 35 is the user (who is viewing the display unit 19) or any of the other users different from the above user. When the display control unit 17 generates a display signal as described above, information can be displayed on the display unit 19. Accordingly, the display control unit 17 has a function of making the display unit 19 display the comment 35 so that a user can be made aware that whether the person who has registered the comment 35 is the user or any of the other users different from the above user. The determination whether the person who has registered the comment 35 is the user or any of the other users can be made by the display control unit 17 comparing a user ID input by the user to the input unit 11 for authentication and a user ID of the person who has registered the comment 35. The display control unit 17 enables identification such that the person who has registered the comment 35 is the user when the user ID input by the user to the input unit 11 for authentication and the user ID of the person who has registered the comment 35 are equal to each other; the display control unit 17 enables identification such that the person who has registered the comment 35 is any of the other users when the user IDs are different from each other.

In the example illustrated in FIG. 4A, the comment 35 registered by a user him/herself who is viewing the display unit 19 is a comment 35a, and the comment 35 registered by any of the other users is a comment 35b. For example, as illustrated in FIG. 4A, the comment 35a can be displayed near the side of the heading 23. In addition, the comment 35b can be displayed in a speech bubble. For example, an object is provided on the right or left side of the heading 23, and a pointer such as a mouse pointer is moved onto the object or the object on which the mouse pointer has been moved is clicked, whereby the speech bubble can be displayed. Here, the display unit 19 can display a registrant of the comment 35b. The example in FIG. 4A illustrates that the main text 25 of the paragraph [0060] is “h₁h₁h₁. h₂h₂h₂h₂h₂h₂h₂.”, and the comment 35a, “transistor structure”, is registered. In addition, the example in FIG. 4A also illustrates that another user “William Smith” has registered “corresponding to claim 1” as the comment 35b, and another user “Mary Brown” has registered “important” as the comment 35b.

Furthermore, the display unit 19 enables a remarkable point registered in the document input to the input unit 11 to be highlighted. Here, the display unit 19 enables highlighting the remarkable point so that a user can be made aware that whether a person who has registered the remarkable point is the user (who is viewing the display unit 19) or any of the other users different from the above user. When the display control unit 17 generates a display signal as described above, information can be displayed on the display unit 19. Accordingly, the display control unit 17 has a function of making the display unit 19 display the remarkable point so that the user can be made aware that whether the person who has registered the remarkable point is the user or any of the other users different from the above user. The determination whether the person who has registered the remarkable point is the user or any of the other users can be made by a method similar to that of the determination whether the person who has registered the comment 35 is the user or any of the other users.

In the example illustrated in FIG. 4A, the remarkable point is hatched to be highlighted. For example, with respect to a paragraph registered as a remarkable point by a user him/herself who is viewing the display unit 19, the paragraph number is hatched to be highlighted. By contrast, with respect to a paragraph registered as a remarkable point by another user, the main text 25 is hatched to be highlighted. Moreover, the full name of the other user who has registered the remarkable point is shown in the speech bubble. For example, a pointer such as a mouse pointer is moved onto a hatched portion of the main text 25 or the hatched portion on which the mouse pointer has been moved is clicked, whereby the speech bubble can be displayed. The example in FIG. 4A illustrates that the main text 25 of the paragraph [0066] is “i₁i₁i₁i₁. i₂i₂i₂i₂i₂i₂i₂i₂.”, and the user him/herself who is viewing the display unit 19 has registered the paragraph as a remarkable point. The example in FIG. 4A also illustrates that the main text 25 of the paragraph [0068] is “i₃i₃i₃i₃. i₄i₄i₄i₄i₄i₄i₄i₄.”, and another user “Mary Brown” has registered the paragraph as a remarkable point. Moreover, the example in FIG. 4A illustrates that the main text 25 of the paragraph [0068] is “i₅i₅i₅i₅. i₆i₆i₆i₆i₆i₆i₆i₆.”, and the user him/herself who is viewing the display unit 19, two of the other users “William Smith” and “Mary Brown” have registered the paragraph as a remarkable point. The highlighting method is not limited to hatching; for example, changing a background color of the heading 23 or the main text 25, changing a font color, enlarging a font size, changing a font type, making the text bold, and underlining the text can be given.

As described above, the comment 35 and the remarkable point can be displayed on the display unit 19. Accordingly, a user of the document viewing device 10 can easily check the important part of the document, for example. In addition, the user of the document viewing device 10 can register the comment 35 and a remarkable point while viewing the display unit 19 as illustrated in FIG. 4A, for example. The registered comment 35 and remarkable point can be displayed immediately on the display unit 19. Thus, the user of the document viewing device 10 can advance the reading comprehension, leaving a memo as a comment, so that the understanding of the document can be deepened. Hence, the document viewing device 10 can be a highly convenient document viewing device.

Furthermore, on the display unit 19, a comment and remarkable point registered by any of the other users can be displayed. Accordingly, information represented by the comment, highly important sentence and drawing, and the like can be shared by the plurality of people. Thus, with use of the document viewing device 10 described above, the work can be executed smoothly. For example, in the case where a plurality of people are in charge of one patent application, the comment made, by one of the people, on the patent application document such as a specification and drawings is shared between the plurality of people. This makes it possible to understand the invention in a short time. Moreover, highly important sentence and drawing, and the like are shared between a plurality of people, whereby an item with high importance can be considered intensively.

In FIG. 4A, the font size of the comment 35b, the font size of the full name of the registrant of the comment 35b, and the font size of the full name of the registrant of the remarkable point are equal to the font sizes of the heading 23 and the main text 25; however, one embodiment of the present invention is not limited thereto. For example, the font size of the comment 35b, the font size of the full name of the registrant of the comment 35b, and the font size of the full name of the registrant of the remarkable point may be smaller than the font sizes of the heading 23 and the main text 25. The same applies to the display unit 19 in the following drawings. Note that in the example illustrated in FIG. 4A, the comment and remarkable point registered with respect to the sentence are shown; however, a comment and remarkable point may be registered with respect to an image, for example. In FIG. 4A, a dashed rectangle, a dotted rectangle, and a dashed-dotted rectangle are provided for description, and they are not displayed on the display unit 19 when one embodiment of the present invention is implemented. The same applies to the display unit 19 in the following drawings.

The display unit 19 may display all the comments 35 and remarkable points registered in the document input to the input unit 11 or does not necessarily display some of the comments 35 and remarkable points. For example, the display unit 19 may display the comment 35 and remarkable point registered by a person having a predetermined attribute (attribute 36). For example, the display unit 19 may display the comment 35 and remarkable point registered by a person whose affiliation is the same as that of a user (who is viewing the display unit 19) of the document viewing device 10. The display unit 19 may display the comment 35 and remarkable point registered by a person whose attribute 36 is specified by the user. When people registering the comment 35 have the attributes 36 different from each other, the viewpoint of the comment 35 may be different. Thus, the comment 35 registered by a person with the predetermined attribute 36 is displayed on the display unit 19, whereby the user of the document viewing device 10 can easily understand the comment 35 in the specific viewpoint, in some cases. Furthermore, when the attributes 36 are different, the tendency of remarkable point is different in some cases. Thus, the remarkable point registered by a person with the predetermined attribute 36 is displayed on the display unit 19, whereby the user of the document viewing device 10 easily recognize a portion relating to the user's work as the remarkable point, in some cases, for example.

When the display control unit 17 generates a display signal as described above, information can be displayed on the display unit 19. As described above, the display control unit 17 has a function of controlling whether or not to make the display unit 19 display the comment 35 depending on the attribute 36 of the person who has registered the comment 35 in the document input to the input unit 11. The display control unit 17 also has a function of controlling whether or not to make the display unit 19 display a remarkable point depending on the attribute 36 of the person who has registered the remarkable point in the document input to the input unit 11.

FIG. 4B is a schematic diagram illustrating an example of a display screen of the display unit 19. In the example illustrated in FIG. 4B, a window 37a and a window 37b are displayed on the display unit 19. Specifically, the window 37a is displayed in the left region of the display unit 19, and the window 37b is displayed in the right region of the display unit 19.

The sum of the comments 35 and the remarkable points registered by each user in each document is displayed in the window 37a. The example in FIG. 4B illustrates that in a document whose document ID 21 is “20045”, the sum of the comments 35 and remarkable points registered by “William Smith” is 3, and the comment 35 or remarkable point registered by “Mary Brown” is 1. The example in FIG. 4B also illustrates that in a document whose document ID 21 is “21369”, the sum of the comments 35 and remarkable points registered by “William Smith” is 2. In the window 37a, the document ID 21 and the number of registered comments 35 and remarkable points are displayed in a list form. Note that in the window 37a, the number of registered comments 35 and the number of registered remarkable points may be each displayed. Furthermore, information on a document may be displayed on the window 37a. For example, in the case where a document represented by the document ID21 is a patent application document, at least one of an application number, a publication number, a registration number, an inventor, an applicant, an application date, a priority date, a publication date, a status, patent classification, a category, a keyword, and the like may be displayed.

The window 37b displays a comment registered in a specific document by a specific person, a comment-given portion, and a remarkable point. Specifically, the window 37b can display a comment, a comment-given portion, and a remarkable point registered by a person designated by a user (who is viewing the display unit 19) of the document viewing device 10. The designation of a person who has registered the comment and the remarkable point can be carried out, for example, by moving a mouse pointer on a full name displayed in the window 37a and clicking the full name. For example, by clicking “William Smith: 3” displayed on the right side of “20045”, the window 37b enables the comment and remarkable point registered by “William Smith” in the document whose document ID is “20045” to be displayed. Furthermore, by clicking “Mary Brown: 1”, the window 37b enables the comment and remarkable point registered by “Mary Brown” in the document whose document ID is “20045” to be displayed. Moreover, by clicking “William Smith: 2” displayed on the right side of “21369”, the window 37b enables the comment and remarkable point registered by “William Smith” in the document whose document ID is “21369” to be displayed.

On the display screen in FIG. 4B, the window 37b displays the document ID 21 and the full name of a person who has registered the comment, the comment-given portion, and the remarkable point, and therebelow, the comment, the comment-given portion and the remarkable point are displayed. Specifically, the window 37b displays the heading 23 indicating the comment-given portion and the remarkable point, the main text 25 or drawing linked to the heading 23, and the comment 35.

FIG. 4B illustrates an example in which the window 37b displays the comment 35, the comment-given portion, and the remarkable point registered by “William Smith” in the document whose document ID is “20045”.

In the example illustrated in FIG. 4B, the main text 25 of the paragraph [0060] is “h₁h₁h₁. h₂h₂h₂h₂h₂h₂.”, and the comment 35, “corresponding to claim 1”, is registered. Also in the example in FIG. 4B, the main text 25 of the paragraph [0068] is “i₅i₅i₅i₅. i₆i₆i₆i₆i₆i₆i₆i₆.” and registered as a remarkable point. Furthermore, in the example in FIG. 4B, the comment 35, “corresponding to claim 2” is registered in “FIG. 2”.

In FIG. 4B, the comment 35 is surrounded by a solid rectangle, whereby the comment 35 is distinguished from the main text 25, for example. Note that the comment 35 is not necessarily surrounded by a solid rectangle. At least one of a background color, a font size, and a font type of the comment 35 may be different from those of the main text 25. Alternatively, one of the comment 35 and the main text 25 may be bolded, or one of the comment 35 and the main text 25 may be underlined. Although not being highlighted in FIG. 4B, the paragraph [0068] that is a remarkable point may be highlighted. The highlighting can be carried out in a manner similar to that in the description for FIG. 4A, for example. Also in the following description, the highlighting can be carried out in a manner similar to that in the description for FIG. 4A, for example.

In the case where the comment 35 is not given to a unit into which text is separated by the heading 23 or the case where a remarkable portion is not registered to any of units into which text is separated by the heading 23, all main text linked to the heading 23 is not necessarily displayed on the display unit 19, for example. In the case where a comment or a remarkable point is given/registered to/in a sentence included in the main text 25, for example, only a sentence given with the comment or registered as the remarkable point may be displayed on the display unit 19. For example, in the case where a comment is given to the sentence “h₁h₁h₁.” in the paragraph [0068] or the case where the sentence “h₁h₁h₁.” is registered as a remarkable point, only “h₁h₁h₁.” is displayed as the main text 25 in the paragraph [0060], and “h₂h₂h₂h₂h₂h₂h₂.” is not necessarily displayed.

In the case where the comment 35 is not given to a unit into which text is separated by the heading 23 or the case where a remarkable point is not registered in a unit into which text is separated by the heading 23, even though all main text linked to the heading 23 is displayed on the display unit 19, the comment-given portion and the remarkable point may be displayed to be distinguished from other portions. For example, in the case where the sentence “i₅i₅i₅i₅.” in the paragraph [0068] is registered as a remarkable point, the main text 25 in the paragraph [0068], “i₅i₅i₅i₅. i₆i₆i₆i₆i₆i₆i₆i₆.”, may be displayed but only “i₅i₅i₅i₅.” may be highlighted

Making the display screen illustrated in FIG. 4B be displayed on the display unit 19, a user of the document viewing device 10 can easily check a comment, a comment-given portion, and a remarkable point registered by a person designated by the user, for example. Thus, the user of the document viewing device 10 can grasp the thought of the person designated by the user and utilize it to execute the work, for example. Hence, the use of the document viewing device 10 enables smooth execution of the work.

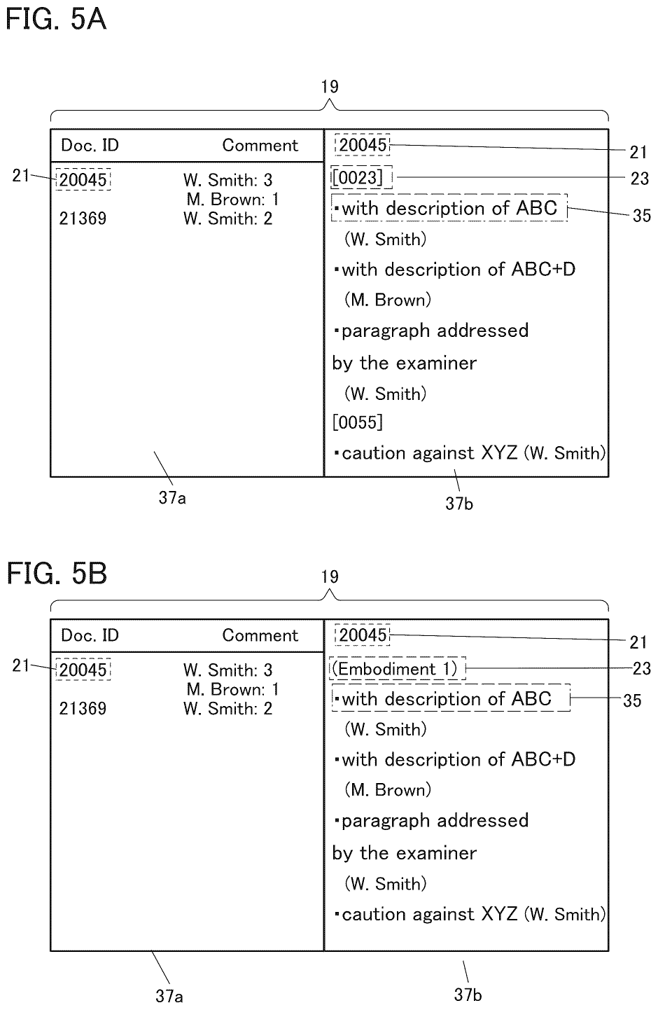

FIG. 5A is a schematic diagram illustrating an example of a display screen of the display unit 19 and is a variation of the display screen illustrated in FIG. 4B. On the display screen illustrated in FIG. 5A, not the sum of registered comments and registered remarkable points but the number of registered comments is displayed in the window 37a. On the display screen illustrated in FIG. 5A, comments registered in a specific document, e.g., a document specified by a user of the document viewing device 10, are displayed regardless of registrants.

In the window 37b, the comment 35 registered in a specific document is displayed. Specifically, in the window 37b, the comment 35 registered in the document designated by a user (who is viewing the display unit 19) of the document viewing device 10 can be displayed. As the designation of the document, the document ID 21 displayed in the window 37a is clicked, for example.

On the display screen illustrated in FIG. 5A, the window 37b displays the document ID 21, and below the document ID 21, the heading 23 indicating the comment-given portion, and the comments 35 are displayed. The window 37b illustrated in FIG. 5A displays full names of persons who have registered the comments 35 with respect to the respective comments 35.

In the example illustrated in FIG. 5A, the comments registered in the document whose document ID 21 is “20045” are displayed. Specifically, in the paragraph [0023], “with description of ABC” and “paragraph addressed by the examiner” are registered as the comments made by “William Smith”, and “with description of ABC+D” is registered as the comment made by “Mary Brown”. In addition, in the paragraph [0055], “caution against XYZ” is registered as the comment made by “William Smith”. Here, when the heading 23 displayed in the window 37b is designated, for example, the main text linked to the heading 23 can be displayed in the window 37a or the window 37b. The heading 23 can be designated by clicking the heading 23, for example.

When the display screen illustrated in FIG. 5A is displayed on the display unit 19, the user of the document viewing device 10 can easily check the comments registered in the designated document. Thus, the user of the document viewing device 10 can grasp the information represented by the comment registered not only by the user him/herself but also by another user, and can execute the work smoothly.

FIG. 5B is a schematic diagram illustrating an example of a display screen of the display unit 19 and is a variation of the display screen illustrated in FIG. 5A. The example in FIG. 5B shows that the heading 23 at an upper level than the paragraph number is displayed and the comment 35 given to the paragraph linked to the heading 23 is displayed. Although FIG. 5B illustrates an example in which the paragraph number is not displayed, the paragraph number may be displayed.

In the example illustrated in FIG. 5B, the comment 35 given to (Embodiment 1) in the document whose document ID 21 is “20045” is displayed. Specifically, to (Embodiment 1), “with description of ABC”, “the paragraph addressed by the examiner”, and “caution against XYZ” are given as the comments 35 made by “William Smith”, and “with description of ABC+D” is given as the comment 35 made by “Mary Brown”. Here, the comment 35 is designated, for example, whereby the comment-given portion can be displayed in the window 37a or the window 37b. The designation can be conducted by clicking the comment 35, for example.

When the display screen illustrated in FIG. 5B is displayed on the display unit 19, a user of the document viewing device 10 can easily check the comment 35 given to a predetermined range in the designated document. Thus, the document viewing device 10 can be a highly convenient document viewing device 10. In addition, the user of the document viewing device 10 can execute the work smoothly.

### Display Screen Example_2

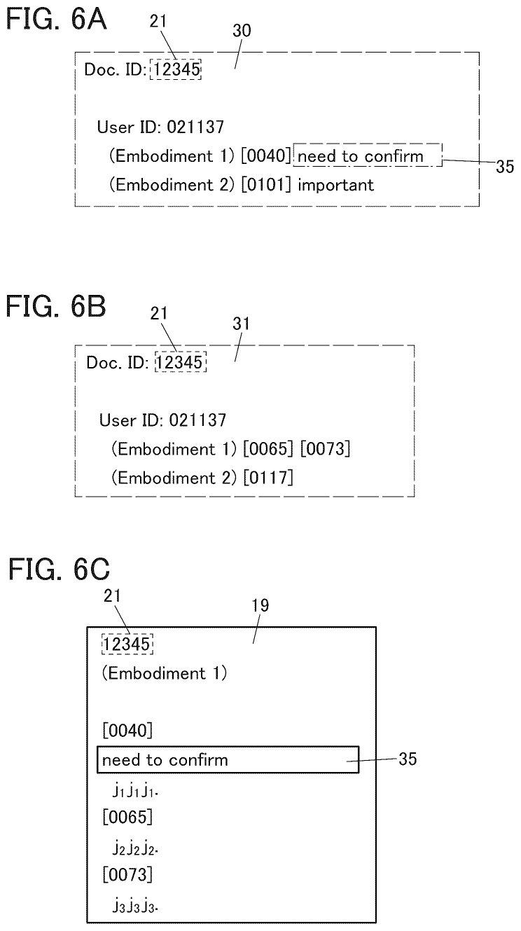

An example of a display screen different from that illustrated in FIG. 4A is described below. FIG. 6A is a schematic diagram illustrating an example of the comment data 30.

FIG. 6A illustrates the comment 35 registered in a document whose document ID 21 is “12345”. The example in FIG. 6A shows that a user whose user ID is “021137” gives the comment 35 “need to confirm” to the paragraph [0040] in (Embodiment 1) and gives the comment 35 “important” to the paragraph [0101] in (Embodiment 2).

FIG. 6B is a schematic diagram illustrating an example of the remarkable data 31. FIG. 6B illustrates a remarkable point registered in the document whose document ID 21 is “12345”. The example in FIG. 6B shows that the user whose user ID is “021137” registers the paragraph [0065 ] and the paragraph [0073 ] in (Embodiment 1) and the paragraph [0117] in (Embodiment 2) as remarkable points.

FIG. 6C is a schematic diagram illustrating an example of a display screen of the display unit 19, and the display screen reflects the comment data 30 illustrated in FIG. 6A and the remarkable data 31 illustrated in FIG. 6B.

The display unit 19 can display the comment 35 given to a specific hierarchical level and for example, can display the comment 35 when a comment-given portion is included in a hierarchical level designated by a user of the document viewing device 10. In addition, the display unit 19 can display a remarkable point included in a specific hierarchical level and for example, can display a remarkable point included in a hierarchical level designated by a user of the document viewing device 10. In the example in FIG. 6C, the display unit 19 displays the comment 35 given to the paragraph included in (Embodiment 1) and the remarkable points in (Embodiment 1) among the comments 35 and the remarkable points registered in the document whose document ID 21 is “12345”.

As described above, the display control unit 17 generates a display signal, whereby information can be displayed on the display unit 19. Thus, the display control unit 17 has a function of displaying the comment 35 on the display unit 19 when a comment-given portion is included in a hierarchical level designated by a user of the document viewing device 10. In addition, the display control unit 17 has a function of making the display unit 19 display a remarkable point when the remarkable point is included in a hierarchical level designated by a user of the document viewing device 10.

As illustrated in FIG. 6A, the comment “need to confirm” is given to (Embodiment 1), and the comment “important” is given to (Embodiment 2). Thus, as illustrated in FIG. 6C, “need to confirm” is displayed as the comment 35 on the display unit 19, but “important” is not displayed.

Furthermore, as illustrated in FIG. 6B, as to the paragraphs registered as the remarkable points, the paragraph [0065 ] and the paragraph [0073] are included in (Embodiment 1), and the paragraph [0117] is included in (Embodiment 2). Thus, as illustrated in FIG. 6C, the paragraph [0065] and the paragraph [0073] are displayed as the remarkable points on the display unit 19, but the paragraph [0117] is not displayed. In FIG. 6C, the main text of the paragraph [0040] is “j₁j₁j₁.”, the main text of the paragraph [0065] is “j₂j₂j₂.”, and the main text of the paragraph [0073] is “j₃j₃j₃.”.

Making the display screen illustrated in FIG. 6C on the display unit 19, a user of the document viewing device 10 can easily check the comment 35 and a remarkable point given/included to/in a predetermined range of a designated document. Thus, the document viewing device 10 can be a highly convenient document viewing device 10. In addition, the user of the document viewing device 10 can execute the work smoothly.

### Display Screen Example_3

As described above, the display control unit 17 has a function of making the display unit 19 display a comment registered in a document input to the input unit 11. Here, the display control unit 17 may have a function of controlling whether or not to make the display unit 19 display the comment depending on the contents of the comment.

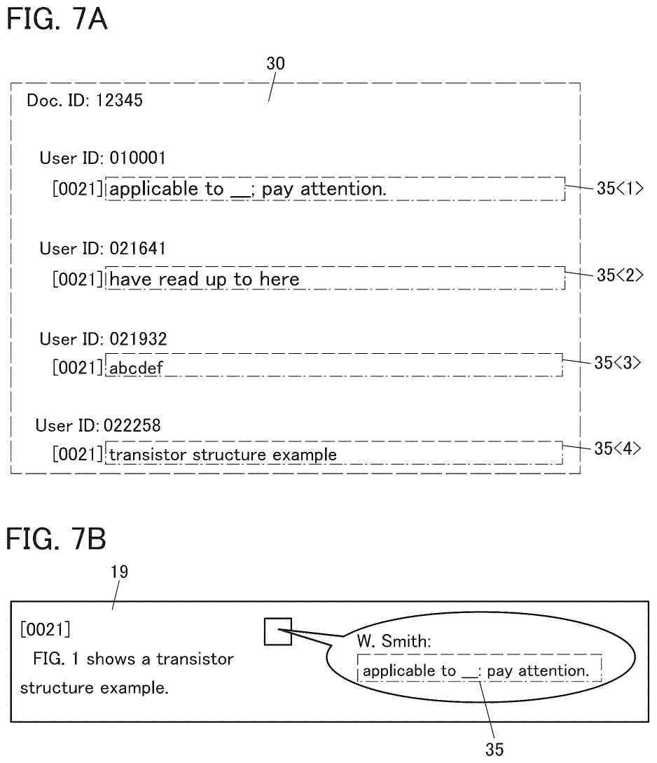

FIG. 7A is a schematic diagram illustrating an example of the comment data 30. FIG. 7A illustrates the comment 35 registered in a document whose document ID 21 is “12345”. The example in FIG. 7A shows that a user whose user ID is “010001” gives the comment 35 “applicable to _; pay attention.” to the paragraph [0021], a user whose user ID is “021641” gives the comment 35 “have read up to here” to the paragraph [0021], a user whose user ID is “021932” gives the comment 35 “abcdef” to the paragraph [0021], and a user whose user ID is “022258” gives the comment 35 “transistor structure example” to the paragraph [0021]. Here, “applicable to ______. Pay attention.” is denoted by a comment 35<1>; “have read up to here” is denoted by a comment 35<2>; “abcdef” is denoted by a comment 35<3>; and “transistor structure example” is denoted by a comment 35<4>.

FIG. 7B is a schematic diagram illustrating an example of a display screen of the display unit 19, and the display screen reflects the comment data 30 illustrated in FIG. 7A. FIG. 7B shows a display example of the main text of the paragraph [0021] and the comment 35 given to the paragraph [0021]. Here, in the example illustrated in FIG. 7B, the main text of the paragraph [0021] is “FIG. 1 shows a transistor structure example”.

The comment 35<1> indicates that important information is written in the paragraph [0021] and can be regarded as an important comment worthy to be shared by a plurality of people. By contrast, the comment 35<2> indicates a private matter and can be regarded as a comment less worthy to be shared by a plurality of people. Thus, the display unit 19 is made to display the comment 35<1> and not to display the comment 35<2>, whereby a user of the document viewing device 10 is less likely to feel bothersome and can focus on an item with high importance. Hence, the document viewing device 10 can be a highly convenient document viewing device. In addition, the user of the document viewing device 10 can execute the work smoothly.

For example, a white list in which a word representing an important comment is registered is prepared. In this case, the display control unit 17 has a function as follows: morphological analysis is performed on the comment 35 to be divided into words; when at least one of the words is included in the white list, the comment 35 is displayed on the display unit 19; when no word is included in the white list, the comment 35 is not displayed on the display unit 19.

Alternatively, for example, a black list in which a word representing no important comment is registered is prepared. In this case, the display control unit 17 has a function as follows: morphological analysis is performed on the comment 35 to be divided into words; when no word is included in the black list, the comment 35 is displayed on the display unit 19; when one or more words are included in the black list, the comment 35 is not displayed on the display unit 19.

Furthermore, both a black list and a white list may be prepared. In this case, the display control unit 17 has a function as follows: morphological analysis is performed on the comment 35 to be divided into words; when the number of words included in the white list is larger than or equal to the number of words included in the black list, the comment 35 is displayed on the display unit 19; when the number of words included in the white list is smaller than the number of words included in the black list, the comment 35 is not displayed on the display unit 19.

Here, only words with a specific part of speech can be registered in the white list. Furthermore, only words with a specific part of speech can be registered in the black list. In this case, the display control unit 17 has a function as follows: morphological analysis is performed on the comment 35 to be divided into words, and only the words with a specific part of speech are screened for the presence or absence of registration in the white list and/or the black list. Note that the white list and the black list can be stored in the memory unit 15. The registration unit 13 can carry out the registration of words in the white list and the black list.

The comment 35<3> is a meaningless comment and can be regarded as a comment less worthy to be shared by a plurality of people. Accordingly, it is preferable not to display the comment 35<3> on the display unit 19, as in the case of the comment 35<2>. For example, a dictionary is prepared. In this case, the display control unit 17 has a function of making the display unit 19 display the comment 35 including one or more words registered in the dictionary and making the display unit 19 avoid displaying the comment 35 including no one words registered in the dictionary, whereby the meaningless comment 35 would not be displayed on the display unit 19. Here, only words with a specific part of speech can be registered in the above dictionary.

The above dictionary can be a general dictionary. Alternatively, a dictionary specialized in a specific field of documents may be created. Further alternatively, in a general dictionary, words tending to be used in a specific field of documents may be registered additionally. The dictionary can be stored in the memory unit 15, and the registration unit 13 can carry out the registration of words in the dictionary.

Here, the display control unit 17 may have a function of controlling whether or not to make the display unit 19 display the comment 35 with use of a machine learning model. The machine learning model can perform learning with supervised learning, for example. For example, with use of a comment displayed on the display unit 19 and a comment not displayed as learning data, the machine learning model can perform learning. Examples of the machine learning model include a neural network, a K-nearest neighbor method, a Naive Bayes classifier, a decision tree, a support vector machine, and a random forest. In particular, when a neural network is used as the machine learning model, the display control unit 17 can control whether or not to make the display unit 19 display the comment 35 with high accuracy. Thus, for example, it is possible to inhibit the comment 35 with high importance from failing to be displayed on the display unit 19 and inhibit the comment 35 with less importance from being displayed on the display unit 19.

The display control unit 17 may have a function of comparing the comment 35 registered in a document input to the input unit 11 with a sentence included in a predetermined range of the document and controlling whether or not to make the display unit 19 display the comment 35. The predetermined range can include a comment-given portion, for example.

Specifically, the display control unit 17 has a function of, for example, determining whether or not to include the same wording as the comment 35 in the comment-given portion, displaying the comment 35 on the display unit 19 when the same wording is not included, and not displaying the comment 35 on the display unit 19 when the same wording is included. Here, the display control unit 17 can make the above determination when predetermined characters such as a punctuation is excluded from the comment 35, for example.

In this specification and the like, the term “punctuation” is used in a broad sense and is not limited to a period and a comma. For example, the term “punctuation” sometimes includes, besides a period and a comma, symbols such as an exclamation mark, a question mark, a middle dot, and parentheses. Furthermore, some of these symbols are referred to as “punctuation” in some cases.

In the example illustrated in FIG. 7A and FIG. 7B, the comment 35<4> is “transistor structure example.”, and “transistor structure example”, which is the composition of the comment

35<4> other than the period, is included in the paragraph [0021] that is the comment-given portion. That is, the comment 35<4> is copied part of the comment-given portion and not a comment disclosing information other than that disclosed in the comment-given portion. Accordingly, the comment 35<4> can be regarded as a comment less worthy to be shared by a plurality of people.

Thus, it is preferable not to display the comment 35<4> on the display unit 19, as in the case of the comment 35<2> and the comment 35<3>. By contrast, for example, “applicable” and “pay attention” included in the comment 35<1> are not included in the paragraph [0021] that is the comment-given portion, and are comments disclosing information other than that disclosed in the comment-given portion. That is, the comment 35<1> can be regarded as a comment worthy to be shared by a plurality of people. Thus, it is preferable to display the comment 35<1> on the display unit 19.

Note that the display control unit 17 may have a function of calculating a similarity between the comment 35 and the comment-given portion. For example, the display control unit 17 can have a function of calculating the similarity between the comment 35 and one or a plurality of sentences included in the comment-given portion. In addition, the display control unit 17 can have a function of making the display unit 19 display the comment 35 with a similarity lower than a predetermined value and making the display unit 19 avoid displaying the comment 35 with a similarity higher than or equal to a predetermined value.

For the calculation of the similarity, for example, the comment 35 and the comment-given portion can be subjected to morphological analysis to be divided into words, and then the similarity can be figured on the basis of the correspondence rate of the words between the comment 35 and the comment-given portion. In this case, a thesaurus may be used. Alternatively, the comment 35 and the comment-given portion can be subjected to morphological analysis to be divided into words, and the words are vectorized, for example, and then, the similarity can be figured using cosine similarity, covariance, unbiased covariance, Pearson's correlation coefficient, deviation pattern similarity, or the like. For example, a neural network can be used for vectorizing the words. Specifically, Word2vec, BoW (Bag of Words), BERT (Bidirectional Encoder Representations from Transformer), or the like, which is an open-sourced algorithm. Note that the vectorization of words can be rephrased as distributed representations of words.

### Display Screen Example_4

When a plurality of comments 35 are registered in a document input to the input unit 11, the display control unit 17 may have a function of comparing the plurality of comments 35 and depending on the comparison result, controlling whether all the comments 35 are displayed on the display unit 19 or only some of the comments 35 are displayed on the display unit 19. For example, when a plurality of comments 35 are registered in one comment-given portion, the display control unit 17 may have a function of comparing the plurality of comments 35 and depending on the comparison result, controlling whether all the comments 35 are displayed on the display unit 19 or only some of the comments 35 are displayed on the display unit 19. For example, when a first comment 35 and a second comment 35 are registered in a document input to the input unit 11, the display control unit 17 may have a function of comparing the first comment 35 and the second comment 35. In addition, the display control unit 17 may have a function of controlling whether both the first comment 35 and the second comment 35 are displayed on the display unit 19 or only one of the first comment 35 and the second comment 35 is displayed on the display unit 19, depending on the comparison result.

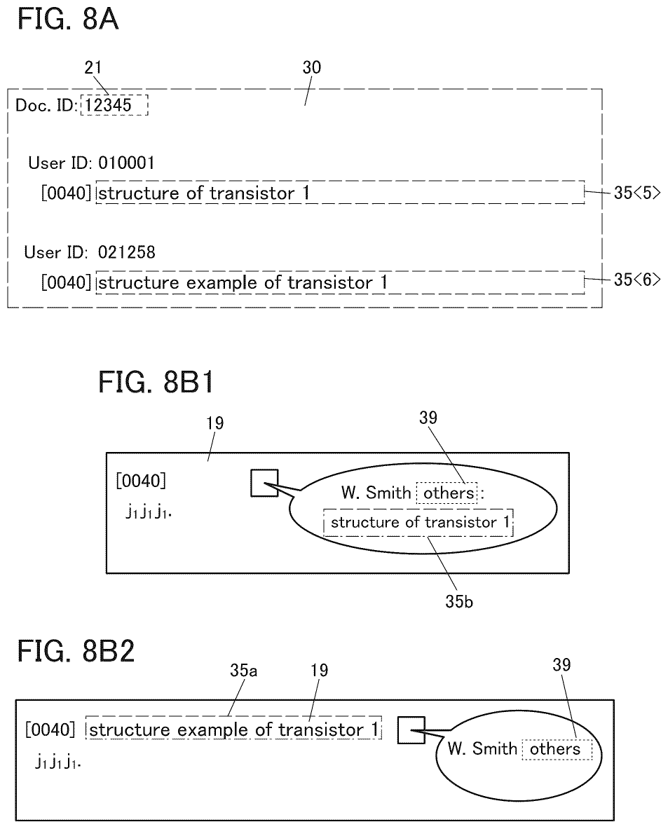

FIG. 8A is a schematic diagram illustrating an example of the comment data 30. FIG. 8A illustrates the comment 35 registered in a document whose document ID 21 is “12345”. In the example in FIG. 8A, a user whose user ID is “010001” gives the comment 35 “structure of transistor 1” to the paragraph [0040] and a user whose user ID is “021258” gives the comment 35 “structure example of transistor 1” to the paragraph [0040]. Here, “structure of transistor 1” is denoted by a comment 35<5>, and “structure example of transistor 1” is denoted by a comment 35<6>.

FIG. 8B1 and FIG. 8B2 are schematic diagrams illustrating examples of a display screen of the display unit 19, and the display screen reflects the comment data 30 illustrated in FIG. 8A. FIG. 8B1 and FIG. 8B2 each illustrate a display example of the main text of the paragraph [0040] and the comment 35 given to the paragraph [0040]. Note that in FIG. 8B1 and FIG. 8B2, the main text of the paragraph [0040] is expressed as “j₁j₁j₁”.

It can be said that the similarly between the comment 35<5> “structure of transistor 1” and the comment 35<6> “structure example of transistor 1” is high because there is only a difference in the presence or absence of “example”. Besides, for both the comment 35<5> and the comment 35<6>, the comment-given portion is the paragraph [0040]. In this case, displaying both the comment 35<5> and the comment 35<6> on the display unit 19 makes a user viewing the display unit 19 feel bothersome, in some case. Thus, only one of the comment 35<5> and the comment 35<6> is displayed and the other is not displayed, whereby the user is less likely to feel bothersome. Hence, the document viewing device 10 can be a highly convenient document viewing device.

Specifically, when a plurality of comments 35 given to the same portion are registered in a document input to the input unit 11, for example, the display control unit 17 has a function of calculating a similarity between the comments 35. Furthermore, the display control unit 17 has a function, for example, of setting the comments 35 with similarities higher than or equal to a predetermined value as the comments 35 similar to each other and making the display unit 19 display one of the similar comments 35 and avoid displaying the other. For example, for the calculation of the similarity, the comment 35 can be subjected to morphological analysis to be divided into words, and then the similarity can be figured on the basis of the correspondence rate of the words. In this case, a thesaurus may be used. Alternatively, the comments 35 are subjected to morphological analysis to be divided into words, and the words are vectorized, for example. Then, the similarity can be figured using cosine similarity, covariance, unbiased covariance, Pearson's correlation coefficient, deviation pattern similarity, or the like. Note that the vectorization of words can be carried out by the above-described method.

In this specification and the like, the term “similar” includes the case of “perfectly match”. For example, the expression “the first comment and the second comment are similar to each other” includes the case where the first comment and the second comment perfectly match each other.

The example of the display screen in FIG. 8B1 shows the case where a person who has registered the comment 35<5> and a person who has registered the comment 35<6> are different from a user (who is viewing the display unit 19) of the document viewing device 10. In the example in FIG. 8B1, the comment 35<5> “structure of transistor 1” is displayed on the display unit 19 as the comment 35b that is the comment 35 registered by another user. Furthermore, a full name of the person who has registered the comment 35<5> “structure of transistor 1”, “William Smith”, is displayed. Moreover, a term 39 indicating the presence of a plurality of people who have registered similar comments 35b is given. In the example in FIG. 8B1, as the term 39, “others” is given after “William Smith”; that is, “William Smith others” is displayed. Accordingly, the user of the document viewing device 10 can be made aware that there is a person who has registered a comment similar to “structure of transistor 1” in the paragraph [0040], other than “William Smith”. Of a plurality of comments similar to each other, a comment registered by a person having the smallest user ID can be displayed on the display unit 19, for example. Furthermore, of a plurality of comments similar to each other, a comment whose registration date and time is the earliest or a comment whose registration date and time is the latest can be displayed on the display unit 19, for example. Furthermore, of a plurality of comments similar to each other, a comment with the smallest number of characters can be displayed on the display unit 19, for example.

In the example illustrated in FIG. 8B1, for example, a pointer such as a mouse pointer is moved onto the term 39 or the term 39 on which the mouse pointer has been moved is clicked, whereby a full name of the person who has registered the comment similar to the comment 35b can be displayed on the display unit 19. For example, a pointer such as a mouse pointer is moved onto “others” or “others” on which the mouse pointer has been moved is clicked, whereby a full name of the person who has registered the comment 35b similar to “structure of transistor 1” can be displayed on the display unit 19.

The example of the display screen in FIG. 8B2 shows that a person who has registered the comment 35<6> is the user (who is viewing the display unit 19) of the document viewing device 10, and a person who has registered the comment 35<5> is another user. In the example illustrated in FIG. 8B2, the comment 35<6> “structure example of transistor 1” is displayed on the display unit 19 as the comment 35a that is the comment 35 registered by the user him/herself who is viewing the display unit 19.

Here, a full name of another user who has registered the comment similar to the comment 35a can be displayed on the display unit 19. In the example illustrated in FIG. 8B2, “William Smith” is displayed as the full name of another user. When there is a fact that two or more persons exist as other users, the term 39 indicating the fact can be displayed. In the example illustrated in FIG. 8B2, “others” is given as the term 39 before “William Smith”, and “William Smith others” is displayed. Accordingly, the user of the document viewing device 10 can be made aware of the presence of a registrant of the comment similar to “structure example of transistor 1” in the paragraph [0040], other than the user him/herself and “William Smith”. Note that in the case where there are two or more other users who have registered the comment similar to the comment 35a, a full name of a user whose user ID is the smallest in the other users can be displayed on the display unit 19, for example. Furthermore, a full name of a user who has registered the comment with the earliest date and time or a user who has registered the comment with the latest date and time, in the other users, can be displayed on the display unit 19, for example.

In the example illustrated in FIG. 8B2, for example, a pointer such as a mouse pointer is moved onto the term 39 or the term 39 on which the mouse pointer has been moved is clicked, whereby a comment similar to the comment 35a displayed on the display unit 19 can be registered, and a full name of the person who has not been displayed on the display unit 19 can be displayed. For example, a pointer such as a mouse pointer is moved onto “others” or “others” on which the mouse pointer has been moved is clicked, whereby a full name of the other user who has registered the comment similar to “structure example of transistor 1”, other than “William Smith”, can be displayed on the display unit 19.

In the examples illustrated in FIG. 8A, FIG. 8B1, and FIG. 8B2, one of the comments 35 that are given to the exactly same portion and having the contents similar to each other is displayed on the display unit 19, and the other comments are not displayed; however, one embodiment of the present invention is not limited thereto. For example, one of the comments 35 whose comment-given portions partly overlap and whose contents are similar to each other may be displayed on the display unit 19, and the others are not necessarily displayed. Alternatively, one of the comments 35 whose comment-given portions do not match each other but are positioned close to each other and whose contents are similar to each other may be displayed on the display unit 19, and the others are not necessarily displayed.

### Display Screen Example_5

The display control unit 17 may have a function of comparing part of sentences in a document input to the input unit 11 and part of sentences in a registration document stored in the memory unit 15 and controlling whether or not a comment registered in the document input to the input unit 11 is displayed on the display unit 19. Assuming that the display control unit 17 has the above function, an example of a processing method using the document viewing device 10 and an example of a display screen will be described below.

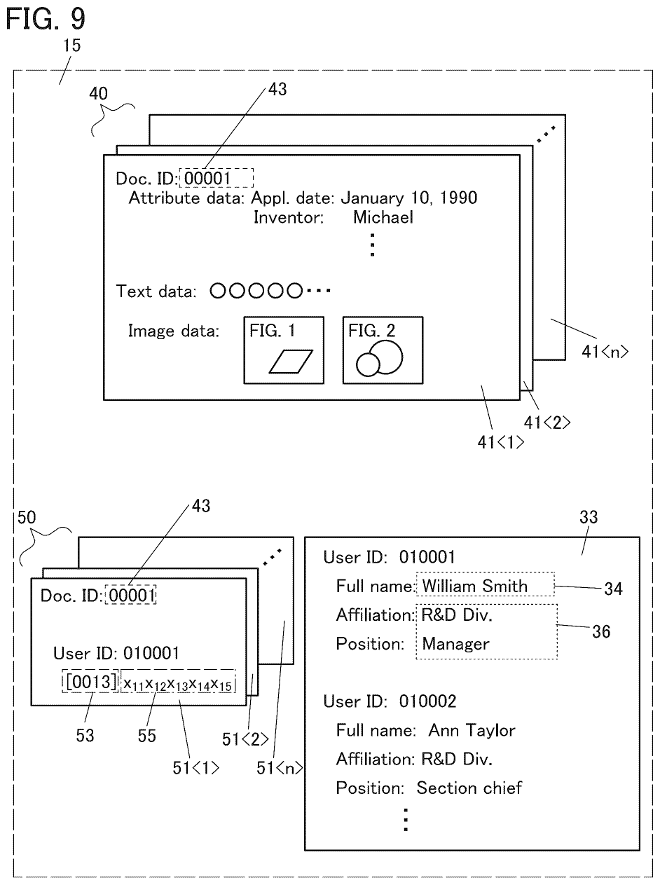

FIG. 9 is a schematic diagram illustrating an example of data stored in the memory unit 15. As illustrated in FIG. 9, the memory unit 15 can store registration document data 41, comment data 51, and the user data 33.

The example in FIG. 9 shows that registration document data 41<1> to registration document data 41<n> (n is an integer greater than or equal to 1) as the registration document data 41 is stored. The registration document data 41 can have a structure similar to that of the document data 20 illustrated in FIG. 2A, and includes document ID 43, attribute data, document data, and image data, for example. FIG. 9 illustrates the application date and the inventor as an example of the attribute, and in the registration document data 41<1>, the application date is “Jan. 10, 1990”, and the inventor is “Michael”. Note that the registration document data 41<1> to the registration document data 41<n> are collectively referred to as a registration document data group 40.

Furthermore, the example in FIG. 9 shows that comment data 51<1> to comment data 51<n> are stored as the comment data 51; that is, the comment data 51 is created and stored for each registration document data 41. The comment data 51 can have a structure similar to that of the comment data 30 illustrated in FIG. 3A, and includes the document ID 43, a heading 53, and a comment 55, for example. The heading 53 indicates a comment-given portion of the registration document. In the example in FIG. 9, the comment data 51<1> indicates a comment registered in the registration document data 41 whose document ID 43 is “00001”. The comment data 51<1> shows that a user whose user ID is “010001” gives the comment 55 “x₁₁z₁₂z₁₃z₁₄z₁₅” to the paragraph [0013]. Note that the comment data 51<1> to the comment data 51<n> are collectively referred to as a comment data group 50.

The example in FIG. 9 shows that a person whose full name 34 is “William Smith”, affiliation in the attribute 36 is “Research and Development division”, and position in the attribute 36 is “Manager” is registered in the user data 33. Also in the example in FIG. 9, a person whose full name 34 is “Ann Taylor”, affiliation in the attribute 36 is “Research and Development division”, and position in the attribute 36 is “Section chief” is registered in the user data 33.

In the following description, description is made on the assumption that the registration document data group 40, the comment data group 50, and the user data 33 are stored in the memory unit 15.

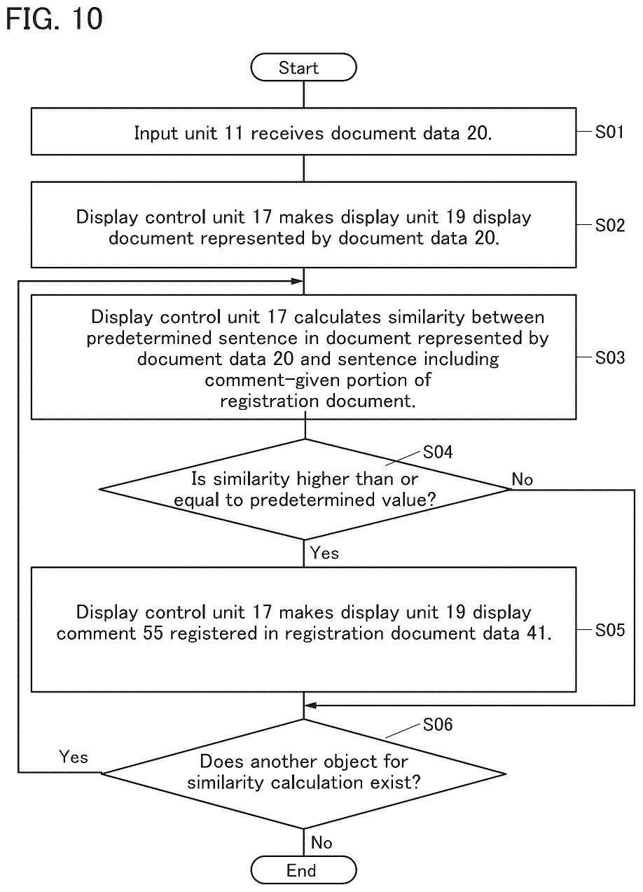

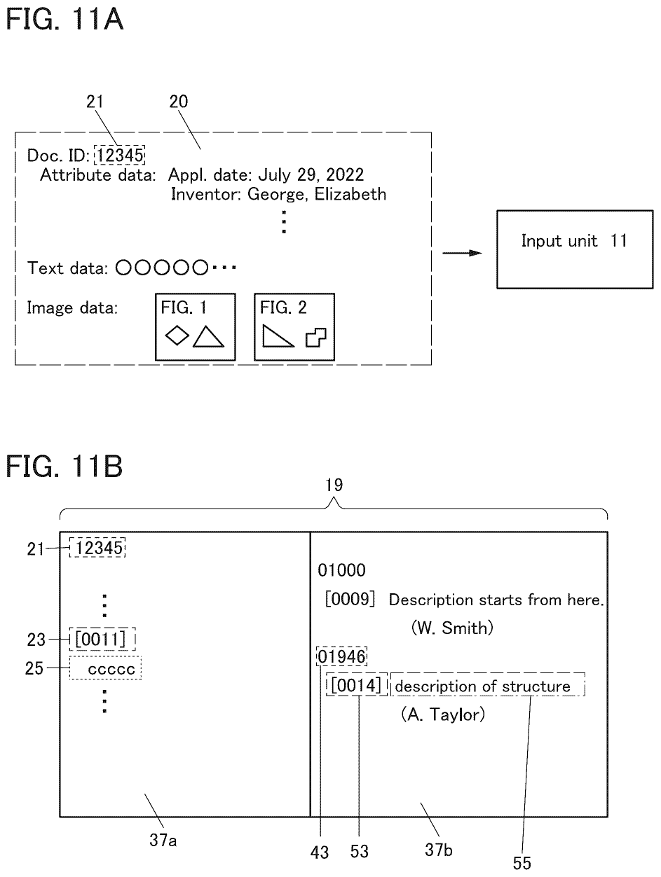

FIG. 10 is a flowchart showing an example of a processing method using the document viewing device 10, i.e., a document viewing method. In the processing method illustrated in FIG. 10, first, as shown in Step S01, the input unit 11 receives the document data 20. Specifically, a user of the document viewing device 10 inputs the document data 20 to the input unit 11, whereby the input unit 11 receives the document data 20. FIG. 11A is a schematic diagram illustrating a state where the document data 20 is input to the input unit 11.

Next, as shown in Step S02, the display control unit 17 makes the display unit 19 display a document represented by the document data 20. For example, the display control unit 17 makes the display unit 19 display a sentence in a document represented by the document data 20. For example, the display control unit 17 makes the display unit 19 display, per paragraph, a sentence in the document represented by the document data 20. Thus, the user of the document viewing device 10 can designate a sentence included in the document represented by the document data 20. Note that the display control unit 17 may make the display unit 19 display a comment registered in the document data 20.

After that, as shown in Step S03, the display control unit 17 calculates a similarity between at least part of the sentence in the document represented by the document data 20 and a sentence including a portion where the comment 55 is given (comment-given portion of the registration document) in the document represented by the registration document data 41. For example, the display control unit 17 calculates a similarity between a sentence designated by the user of the document viewing device 10 and the sentence including a comment-given portion of the registration document. For example, when the comment 55 is given to the paragraph in the document represented by the registration document data 41, the display control unit 17 calculates a similarity between a paragraph, designated by the user of the document viewing device 10, in paragraphs in the document represented by the document data 20 and the comment-given portion of the registration document. For example, when the comment 55 is given to one or more sentences or one character or a plurality of consecutive characters in the document represented by the registration document data 41, the display control unit 17 can calculate a similarity between a paragraph, designated by the user of the document viewing device 10, in paragraphs in the document represented by the document data 20 and a paragraph including the comment-given portion of the registration document.

For example, the display control unit 17 can calculate the similarity in such a manner that the comment-given portion and the comment-given portion of the registration document are subjected to morphological analysis to be divided into words, and the similarity is figured on the basis of the correspondence rate of the words. In this case, a thesaurus may be used. Alternatively, the calculation of similarity by the display control unit 17 can be performed in such a manner that the comment-given portion and the comment-given portion of the registration document are subjected to morphological analysis to be divided into words, and the words are vectorized, for example. Then, the similarity can be figured using cosine similarity, covariance, unbiased covariance, Pearson's correlation coefficient, deviation pattern similarity, or the like. Note that the vectorization of words can be carried out by the above-described method.

Next, as shown in Step S04, the display control unit 17 determines whether or not the similarity is higher than or equal to a predetermined value. In the case where the similarity is higher than or equal to a predetermined value (Yes), as shown in Step S05, the display control unit 17 makes the display unit 19 display the comment 55 registered in the registration document data 41. Specifically, the display control unit 17 makes the display unit 19 display the comment 55 given to the comment-given portion of the registration document, whose similarity is calculated in Step S03, for example. In the case where the similarity is less than a predetermined value (No), Step S05 is not performed. That is, the comment 55 is not displayed on the display unit 19. Note that in Step S05, for example, the display control unit 17 may make the display unit 19 display the comment-given portion of the registration document, whose similarity is calculated in Step S03.

Next, as shown in Step S06, the display control unit 17 determines whether or not another object for similarity calculation exits. For example, when the comment-given portions of the registration document included in the registration document data 41<1> to the registration document data 41<n> illustrated in FIG. 9 are objects for similarity calculation, whether or not the comment-given portion of the registration document, whose similarity has not been calculated, is included in the registration document data 41<1> to the registration document data 41<n>. In the case where the comment-given portion whose similarity has not been calculated exists (Yes), Step S03 to Step S06 are repeatedly performed until the similarities of all the objects are figured. In the case where the comment-given portion whose similarity has not been calculated does not exist (No), the document viewing device 10 terminates the processing.

Note that the object for similarity calculation may be all the registration document data 41 stored in the memory unit 15 or some of the registration document data 41. For example, the registration document data 41 in the same field as that for the document data 20 or the field similar to that for the document data 20 may be the object for similarity calculation. For example, when the document data 20 represents a document relating to a MOS (Metal-Oxide-Semiconductor) transistor, only the registration document data 41 relating to the MOS transistor may be the object for similarity calculation, or not only the registration document data 41 relating to the MOS transistor but also the registration document data 41 relating to a bipolar transistor may be the object for similarity calculation. Moreover, for example, all the registration document data 41 relating to semiconductors may be the object for similarity calculation.

The fields of the document data 20 and the registration document data 41 can be registered in advance. For example, the registration unit 13 may determine the field of the document data 20 on the basis of a document represented by the document data 20 and determine the field of the registration document data 41 on the basis of a document represented by the registration document data 41. For example, when the document data 20 and the registration document data 41 are patent application documents, the registration unit 13 may determine the above field on the basis of the title of the invention. Furthermore, for example, the registration unit 13 may determine the field of the document data 20 on the basis of the attribute of the document data 20 and determine the field of the registration document data 41 on the basis of the attribute of the registration document data 41. For example, the registration unit 13 may determine the above field on the basis of the patent classification.

FIG. 11B is a schematic diagram illustrating an example of a display screen of the display unit 19 after the document viewing device 10 carries out the processing illustrated in FIG. 10. In the example illustrated in FIG. 11B, the window 37a and the window 37b are displayed on the display unit 19. Specifically, the window 37a is displayed in the left region of the display unit 19, and the window 37b is displayed in the right region of the display unit 19.

A document represented by the document data 20 is displayed in the window 37a. In the example illustrated in FIG. 11B, a document, represented by the document data 20, whose document ID 21 is “12345” is displayed. Also in the example illustrated in FIG. 11B, the heading 23 indicates that is the paragraph number, and the main text 25 in the paragraph [0011] is “ccccc”. For example, when a comment is given to the paragraph [0011], the comment is also displayed on the display unit 19, for example in the window 37a.

The window 37b displays the document ID 43 specifying the registration document data 41, the heading 53 indicating the comment-given portion of the registration document, which is determined to have the similarity higher than or equal to a predetermined value by the processing illustrated in FIG. 10, and the comment 55. In addition, a full name of a person who has registered the comment 55 can be displayed. The example in FIG. 11B shows that “William Smith” gives the comment 55 “Description starts from here.” to the paragraph [0009] in a document, represented by the registration document data 41, whose document ID 43 is “01000”, and “Ann Taylor” gives the comment 55 “description of structure” to the paragraph [0014] in a document, represented by the registration document data 41, whose document ID 43 is “01946”.

When the screen illustrated in FIG. 11B is displayed on the display unit 19, the heading 23 is clicked, for example, a sentence whose similarity with a sentence including a comment-given portion of the registration document is calculated can be designated. For example, [0011] is clicked, whereby the display control unit 17 can calculate, in Step S03, the similarity between the main text 25 “ccccc” in the paragraph [0011] and the comment-given portion of the registration document. Then, the comment 55 given to a paragraph with the similarity higher than or equal to a predetermined value can be displayed in the window 37b.

Furthermore, the main text can be displayed by designating the heading 53 or the comment 55. As the designation of the heading 53 or the comment 55, the heading 53 or the comment 55 can be clicked. For example, clicking or [0009] “Description starts from here. (William Smith)” makes the main text of the paragraph [0009] to be displayed.

When the screen illustrated in FIG. 11B is displayed on the display unit 19, the user of the document viewing device 10 can view the comment registered in a document different from the document input to the input unit 11. Specifically, of comments registered in a document different from the document input to the input unit 11, a comment that can be viewed by the user of the document viewing device 10 is a comment given to a sentence similar to a sentence in the document input to the input unit 11, for example. Thus, the user of the document viewing device 10 can effectively obtain the knowledge of another user and can inhibit oversight of an important item, for example. Hence, the user of the document viewing device 10 can execute the work smoothly.

Note that the similarity with a sentence including the comment-given portion of the registration document may be calculated on a sentence other than the sentence designated by the user of the document viewing device 10. For example, the similarity with the comment-given portion of the registration document may be calculated on all the paragraphs in a document represented by the document data 20 which the user inputs to the input unit 11. In this case, the heading 23 displayed in the window 37a is designated, for example, whereby the comment 55 given to a paragraph similar to the paragraph linked to the heading 23 can be displayed in the window 37b in a short time after the heading 23 is designated. For example, the paragraph displayed in the window 37a is designated, whereby the comment 55 given to a paragraph similar to the paragraph can be displayed in the window 37b in a short time after the paragraph displayed in the window 37a is designated.

### Display Screen Example_6

The display control unit 17 may have a function of comparing a comment registered in a document input to the input unit 11 and a comment registered in a registration document stored in the memory unit 15 and controlling whether or not a comment-given portion of the registration document is displayed on the display unit 19. Assuming that the display control unit 17 has such a function, an example of a processing method using the document viewing device 10 and an example of a display screen are described below. Note that the description is made on the assumption that the memory unit 15 stores the registration document data group 40, the comment data group 50, and the user data 33 as illustrated in FIG. 9.

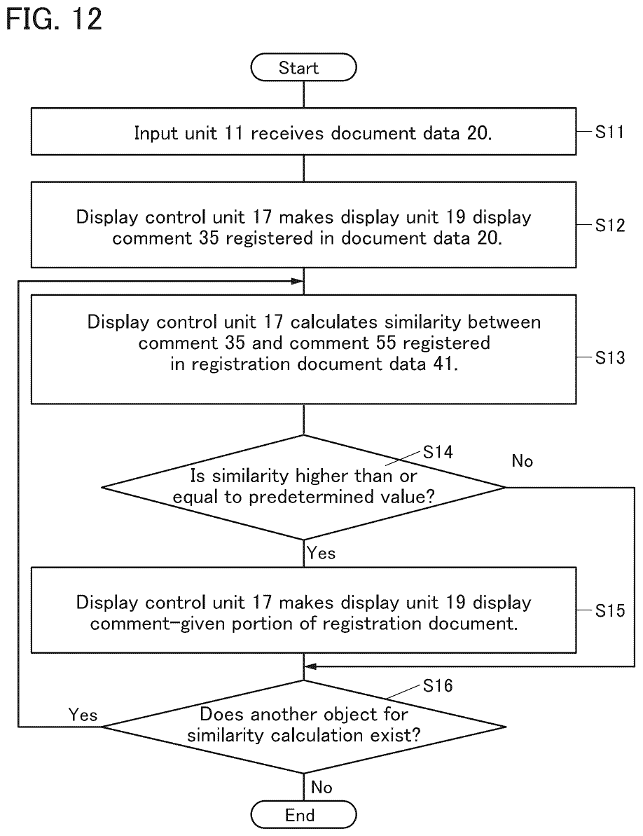

FIG. 12 is a flowchart showing an example of a processing method using the document viewing device 10, i.e., a document viewing method. In the processing method illustrated in FIG. 12, first, as shown in Step S11, the input unit 11 receives the document data 20. Specifically, as in Step S01 shown in FIG. 10 and FIG. 11A, a user of the document viewing device 10 inputs the document data 20 to the input unit 11, whereby the input unit 11 receives the document data 20.

Next, as shown in Step S12, the display control unit 17 makes the display unit 19 display the comment 35 registered in the document data 20. Accordingly, the user of the document viewing device 10 can designate the comment 35 registered in the document data 20. Note that the display control unit 17 may make the display unit 19 display a portion given to the comment 35, specifically, a sentence or a drawing to which the comment 35 is given, for example.

After that, as shown in Step S13, the display control unit 17 calculates the similarity between the comment 35 and the comment 55 registered in the registration document data 41. For example, the display control unit 17 calculates the similarity between the comment 35 designated by the user of the document viewing device 10 and the comment 55 registered in the registration document data 41.

For the calculation of the similarity, first, the display control unit 17 carries out morphological analysis on the comment 35 and the comment 55 to divide them into words, for example. Next, the display control unit 17 extracts the word in a specific category from the comment 35. For example, the display control unit 17 extracts a proper noun from the comment 35. Note that the display control unit 17 does not necessarily extract all the proper nouns and may extract only a proper noun in a specific category, for example. For example, the display control unit 17 may extract only a personal name or only a personal name and a company name. Furthermore, the display control unit 17 may extract a technical term from the comment 35, for example. In this case, the display control unit 17 does not necessarily extract all the technical terms from the comment 35 and may only some of the technical terms. For example, the display control unit 17 may extract a technical term related to the field of the document data 20 from the comment 35. Furthermore, for example, the display control unit 17 may extract a technical term with high TF-IDF (Term Frequency-Inverse Document Frequency) in a document represented by the document data 20, specifically, a technical term whose TF-IDF is higher than or equal to a predetermined value, from the comment 35.

After that, the display control unit 17 extracts a word from the comment 55, which is the same as the word extracted from the comment 35. The number of words extracted from the comment 55 can be the similarity between the comment 35 and the comment 55. Here, the display control unit 17 may use a thesaurus to extract a word from the comment 55, which is similar to the word extracted from the comment 35, for example.

For the calculation of the similarity between the comment 35 and the comment 55, for example, the display control unit 17 carries out morphological analysis on the comment 35 and the comment 55 to divide them into words, and then the similarity may be figured on the basis of the correspondence rate of the words. In this case, a thesaurus may be used. Alternatively, the calculation of similarity may be performed in such a manner that the display control unit 17 carries out morphological analysis on the comment 35 and the comment 55 to divide them into words, and the words are vectorized, for example. Then, the similarity may be figured using cosine similarity, covariance, unbiased covariance, Pearson's correlation coefficient, deviation pattern similarity, or the like. Note that the vectorization of words can be carried out by the above-described method.

Next, as shown in Step S14, the display control unit 17 determines whether or not the similarity is higher than or equal to a predetermined value. In the case where the similarity is higher than or equal to a predetermined value (Yes), as shown in Step S15, the display control unit 17 makes the display unit 19 display a comment-given portion of the registration document. Specifically, the display control unit 17 makes the display unit 19 display a sentence or a drawing given the comment 55 whose similarity is calculated in Step S13, for example. In the case where the similarity is less than a predetermined value (No), Step S15 is not performed. That is, the comment-given portion of the registration document is not displayed on the display unit 19. Note that in Step S15, for example, the display control unit 17 may make the display unit 19 display the comment 55 whose similarity is calculated in Step S13.

Next, as shown in Step S16, the display control unit 17 determines whether or not another object for similarity calculation exits. For example, when the comment 55 registered in the registration document data 41<1> to the registration document data 41<n> illustrated in FIG. 9 is an object for similarity calculation, whether or not the comment 55 whose similarity has not been calculated, is included in the above data. In the case where the comment 55 whose similarity has not been calculated exists (Yes), Step S13 to Step S16 are repeatedly performed until the similarities of all the objects are figured. In the case where the comment 55 whose similarity has not been calculated does not exist (No), the document viewing device 10 terminates the processing. Note that as in Step S06 shown in FIG. 10, the object for similarity calculation may be all the registration document data 41 stored in the memory unit 15 or may be some of the registration document data 41.

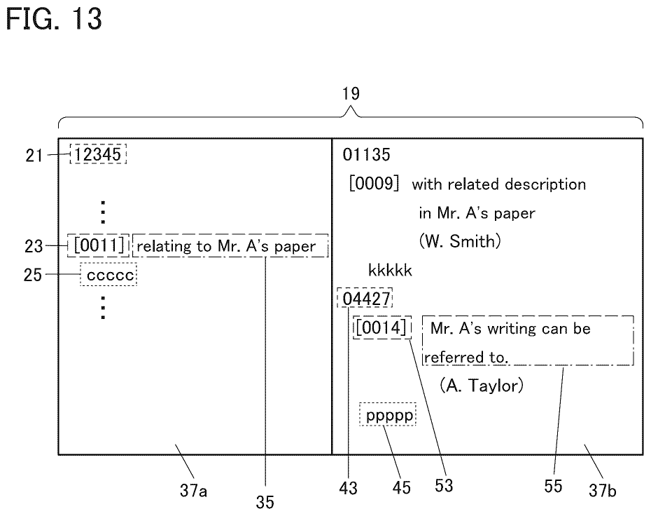

FIG. 13 is a schematic diagram illustrating an example of a display screen of the display unit 19 in the document viewing device 10 that has executed the processing shown in FIG. 12. In the example illustrated in FIG. 13, the window 37a and the window 37b are displayed on the display unit 19. Specifically, the window 37a is displayed in the left region of the display unit 19, and the window 37b is displayed in the right region of the display unit 19.

A document represented by the document data 20 is displayed in the window 37a. The example in FIG. 13 shows that the document represented by the document data 20, whose document ID 21 is “12345”, and the comment 35 registered in the document are displayed. Here, the comment 35 displayed in the window 37a may be not only a comment registered by the user (who is viewing the display unit 19) of the document viewing device 10 but also a comment registered by another user. In the example in FIG. 13, the heading 23 indicates [0011] that is the paragraph number, and the main text 25 of the paragraph [0011] is “ccccc”. Also in the example in FIG. 13, the comment 35 “relating to Mr. A′s paper” is given to the paragraph [0011].

In the window 37b, the document ID 43 specifying the registration document data 41, the comment 55 whose similarity is determined to be higher than or equal to a predetermined value in the processing shown in FIG. 12, the heading 53 indicating a comment-given portion of the registration document, and a main text 45 of the heading 53 are displayed. In addition, a full name of a person who has registered the comment 55 can be displayed. The example in FIG. 13 shows that “William Smith” gives the comment 55 “with related description in Mr. A's paper” to the paragraph [0008] in a document represented by the registration document data 41, whose document ID 43 is “01135”, and the main text 45 of the paragraph is “kkkkk”. Also in the example in FIG. 13, “Ann Taylor” gives the comment 55 “Mr. A′s writing can be referred to.” to the paragraph [0014] in a document represented by the registration document data 41, whose document ID 43 is “04427”, and the main text 45 of the paragraph is “ppppp”. Note that when the comment 55 is given to a drawing, the drawing can be displayed in the window 37b.

Here, not only a paragraph that is a comment-given portion of the registration document but also paragraphs that are present before and after the paragraph may be displayed in the window 37b. For example, when the comment 55 is given to one or more sentences or one character or a plurality of consecutive characters in the document represented by the registration document data 41, the main text 45 to be displayed may be only the comment-given portion of the registration document or the whole of the paragraph including the comment-given portion of the registration document. Furthermore, the whole of the paragraph including the comment-given portion of the registration document and paragraphs that are present before and after the paragraph may be displayed.

When the screen shown in FIG. 13 is displayed on the display unit 19, clicking the comment 35, for example, enables the designation of the comment 35 subjected to calculation of the similarity with the comment 55. For example, clicking “relating to Mr. A′s paper” enables the display control unit 17 to calculate the similarity between the “relating to Mr. A′s paper” and the comment 55 in Step S13. Then, the comment 55 whose similarity is higher than or equal to a predetermined value can be displayed in the window 37b. Here, the comment 35, “relating to Mr. A's paper”, includes “Mr. A” as a proper noun. Thus, in Step S13 shown in FIG. 12, the display control unit 17 can extract “Mr. A”, for example. In addition, the comments 55, “with related description in Mr. A's paper” and “Mr. A's writing can be referred to.”, include the word, “Mr. A”, extracted by the display control unit 17. Accordingly, the similarity of the comment 35 “relating to Mr. A's paper” with each of the comments 55 “with related description in Mr. A's paper” and “Mr. A's writing can be referred to.” can be 1. Thus, in the case where the predetermined value of the similarity in Step S14 shown in FIG. 12 is 1, a paragraph where “with related description in Mr. A′s paper” is registered as the comment 55 and a paragraph where “Mr. A's writing can be referred to.” is registered as the comment 55 are displayed in the window 37b, for example.

When the screen shown in FIG. 13 is displayed on the display unit 19, the user of the document viewing device 10 can view a comment registered in a document different from the document input to the input unit 11. Specifically, the user of the document viewing device 10 can view a sentence given a comment that is similar to a comment registered in the document input to the input unit 11 but is registered in a different document. Accordingly, the user of the document viewing device 10 can view a sentence or a drawing that is related in the contents but does not have similarity in the wordings, for example, through extraction from the registration document. Thus, the user of the document viewing device 10 can be made aware of the presence of a document having the description related to a document which the user is taking notice of, for example. Hence, the user of the document viewing device 10 can execute the work smoothly.

Note that the similarity of the comments 35, other than the comment 35 designated by the user of the document viewing device 10, with the comment 55 may be calculated. For example, the similarity with the comment 55 may be calculated on each of all the comments 35 registered in the document, represented by the document data 20, which the user has input to the input unit 11. In this case, for example, the comment 35 displayed in the window 37a is designated, whereby the sentence, drawing, and the like to which the comment 55 similar to the comment 35 is given can be displayed in the window 37b in a short time after the comment 35 is designated.

As described above, the document viewing device of one embodiment of the present invention can be a document viewing device that contributes to smooth execution of the work. Furthermore, the document viewing device of one embodiment of the present invention can be a highly convenient document viewing device.

The plurality of structure examples described in this embodiment can be combined with each other as appropriate. For example, the display screen illustrated in FIG. 4A can be displayed in the window 37a illustrated in FIG. 11B and the window 37a illustrated in FIG. 13.

This embodiment can be combined with the other embodiments as appropriate.

### Embodiment 2

In this embodiment, a document viewing system using a document viewing device of one embodiment of the present invention will be described with reference to drawings.

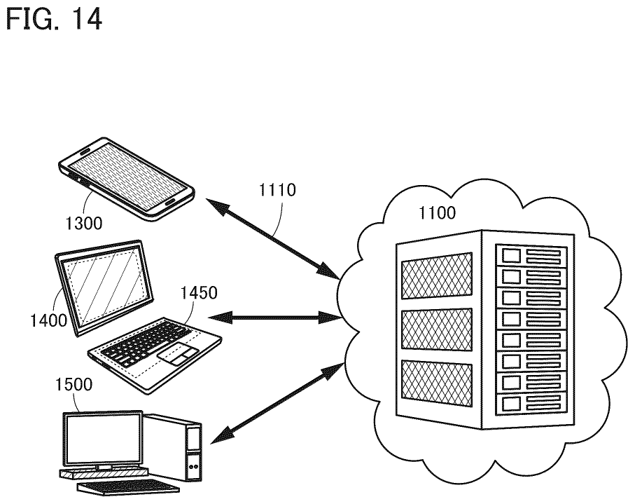

FIG. 14 is a conceptual diagram of a document viewing system of this embodiment.

The document viewing system illustrated in FIG. 14 includes a server 1100 and terminals (also referred to as electronic devices). Communication between the server 1100 and each terminal is conducted via an Internet connection 1110. The server 1100 and the terminal can have a function of the document viewing system of one embodiment of the present invention.

One or both of the server 1100 and the terminal can be provided with the input unit 11, the registration unit 13, the memory unit 15, the display control unit 17, and the display unit 19 included in the document viewing device 10 illustrated in FIG. 1 of Embodiment 1. For example, the server 1100 can be provided with the registration unit 13, the memory unit 15, and the display control unit 17, and the terminal can be provided with the input unit 11 and the display unit 19.

The server 1100 is capable of performing an arithmetic operation using data input from the terminal via the Internet connection 1110. The server 1100 is capable of transmitting an arithmetic operation result to the terminal via the Internet connection 1110. Accordingly, the burden of arithmetic operation on the terminal can be reduced.

In this specification and the like, the document viewing system refers to a set of elements for achieving functions of the document viewing device. For example, in the case where the function of the document viewing device can be established with the server, the terminal, and the Internet connection transmitting and receiving data between the server and the terminal, the document viewing device is regarded as being constructed with the server, the terminal, and the Internet connection.

In FIG. 14, an information terminal 1300, an information terminal 1400, and an information terminal 1500 are shown as the terminals. The information terminal 1300 is an example of a portable information terminal such as a smartphone. The information terminal 1400 is an example of a tablet terminal. When the information terminal 1400 is connected to a housing 1450 with a keyboard, the information terminal 1400 can be used as a laptop information terminal. The information terminal 1500 is an example of a desktop information terminal.

With such a structure, a user can access the server 1100 from the information terminal 1300, the information terminal 1400, the information terminal 1500, and the like. Then, through the communication via the Internet connection 1110, the user can receive a service offered by an administrator of the server 1100. Examples of the service include a service with use of the document viewing device of one embodiment of the present invention. For the service, an artificial intelligence may be used in the server 1100.

### REFERENCE NUMERALS

10: document viewing device, 11: input unit, 13: registration unit, 15: memory unit, 17: display control unit, 19: display unit, 20: document data, 22: sentence data, 23: heading, 25a: main text, 25b: main text, 25c: main text, 25d: main text, 25e: main text, 25f: main text, 25g: main text, 25h: main text, 25i: main text, 25: main text, 30: comment data, 31: remarkable data, 33: user data, 34: full name, 35a: comment, 35b: comment, 35: comment, 36: attribute, 37a: window, 37b: window, 39: term, 40: registration document data group, 41: registration document data, 45: main text, 50:

comment data group, 51: comment data, 53: heading, 55: comment, 1100: server, 1110: Internet connection, 1300: information terminal, 1400: information terminal, 1450: housing, 1500: information terminal

1. A document viewing device comprising:
an input unit, a registration unit, a display control unit, and a display unit,
wherein the input unit is configured to receive a document designated by a user,
wherein the registration unit is configured to register a comment in a comment-given portion that is a part of the document, and
wherein the display control unit is configured to make the display unit display the comment so that the user is made aware that whether a person who has registered the comment is the user or any of the other users.

2. The document viewing device according to claim 1,
wherein the registration unit is configured to register a part of the document as a remarkable point, and
wherein the display control unit is configured to make the display unit display the remarkable point so that the user is made aware of whether a person who has registered the remarkable point is the user or any of the other users.

3. The document viewing device according to claim 1,
wherein the display control unit is configured to control whether or not to make the display unit display the comment depending on an attribute of any of the other users.

4. The document viewing device according to claim 2,
wherein the display control unit is configured to control whether or not to make the display unit display the comment depending on an attribute of any of the other users who has registered the comment, and
wherein the display control unit is configured to control whether or not to make the display unit display the remarkable point depending on an attribute of any of the other users who has registered the remarkable point.

5. The display viewing device according to claim 1,
wherein the document is hierarchized with a heading and a main text linked to the heading, and
wherein the display control unit is configured to make the display unit display the comment when the comment-given portion is included in a hierarchical level designated by the user.

6. The display viewing device according to claim 2,
wherein the document is hierarchized with a heading and a main text linked to the heading, and
wherein the display control unit is configured to make the display unit display the comment when the comment-given portion is included in a hierarchical level designated by the user, and
wherein the display control unit is configured to make the display unit display the remarkable point when the remarkable point is included in a hierarchical level designated by the user.

7. The display viewing device according to claim 1,
wherein the display control unit is configured to control whether or not to make the display unit display the comment depending on a content of the comment.

8. The display viewing device according to claim 1,
wherein the display control unit is configured to compare the comment and a sentence included in a predetermined range of the document and to control whether or not to make the display unit display the comment, and
wherein the predetermined range comprises the comment-given portion.

9. The display viewing device according to claim 1,
wherein the display control unit is configured to compare a first comment and a second comment when the comment comprises the first comment and the second comment and to control whether both the first comment and the second comment are displayed on the display unit or only one of the first comment and the second comment is displayed on the display unit.

10. The display viewing device according to claim 9,
wherein the display control unit is configured to calculate a first similarity that is a similarity between the first comment and the second comment and to make the display unit display only one of the first comment and the second comment when the first similarity is higher than or equal to a predetermined value.

11. The display viewing device according to claim 1, comprising a memory unit,
wherein the memory unit is configured to store a plurality of registration documents,
wherein the comment is given to a comment-given portion of the registration document that is a part of a sentence in any of the registration documents, and
wherein the display control unit is configured to calculate a second similarity that is a similarity between at least a part of a sentence in the document and the sentence including the comment-given portion of the registration document and to make the display unit display the comment given to the comment-given portion of the registration document when the second similarity is higher than or equal to a predetermined value.

12. A document viewing device comprising:
an input unit, a registration unit, a memory unit, a display control unit, and a display unit,
wherein the input unit is configured to receive a document designated by a user,
wherein the registration unit is configured to register a first comment in a first comment-given portion that is a part of the document,
wherein the memory unit is configured to store a plurality of registration documents,
wherein a second comment is registered in a second comment-given portion that is a part of any of the registration documents,
wherein the display control unit is configured to make the display unit display the first comment, and
wherein the display control unit is configured to compare the first comment and the second comment and to control whether or not to make the display unit display the second comment-given portion.

13. The document viewing device according to claim 12,
wherein the display control unit is configured to calculate a first similarity that is a similarity between the first comment and the second comment and to make the display unit display the second comment-given portion when the first similarity is higher than or equal to a predetermined value.

14. The document viewing device according to claim 12,
wherein the display control unit is configured to make the display unit display the first comment so that the user is made aware that whether a person who has registered the first comment is the user or any of the other users.

15. The document viewing device according to claim 14,
wherein the display control unit is configured to control whether or not to make the display unit display the first comment depending on a relation between an attribute of the user and an attribute of any of the other users.

16. The document viewing device according to claim 12,
wherein each of the document and the registration document is hierarchized with a heading and a main text linked to the heading, and
wherein the display control is configured to inhibit the display unit from displaying the first comment and the second comment when the first comment-given portion is not included in a hierarchical level designated by the user.

17. The document viewing device according to claim 12,
wherein the display control unit is configured to control whether or not to make the display unit display the first comment and the second comment depending on a content of the first comment.

18. The document viewing device according to claim 12,
wherein the display control unit is configured to compare the first comment and a sentence included in a predetermined range of the document and to control whether or not to make the display unit display the first comment and the second comment, and
wherein the predetermined range comprises the first comment-given portion.

19. The document viewing device according to claim 12,
wherein when the first comment registered in the document is a plurality of first comments, the display control unit is configured to compare the plurality of first comments and to control whether to display all the first comments or only some of the first comments on the display unit.

20. The document viewing device according to claim 19,
wherein the display control unit is configured to calculate a plurality of second similarities that are each a similarity between the plurality of first comments and to make the display unit display only some of the first comments whose second similarity is higher than or equal to a predetermined value.

21. The document viewing device according to claim 12,
wherein the registration unit is configured to register a part of the document as a remarkable point, and
wherein the display control unit is configured to make the display unit display the remarkable point so that the user is made aware that whether a person who has registered the remarkable point is the user or any of the other users.
